(19) United States
(12) Patent Application Publication
(10) Pub. No.: US 2025/0390531 A1
(43) Pub. Date: Dec. 25, 2025

(54) METHODS AND SYSTEMS FOR PROVIDING AND RECOMMENDING GEOGRAPHICALLY LINKED AUDIO-VISUAL EXPERIENCES FROM CULTURAL INSTITUTIONS

(71) Applicant: TIME SITE TECHNOLOGIES LLC, San Francisco, CA (US)

(72) Inventor: Alex Bien-Aime, San Francisco, CA (US)

(73) Assignee: Time Site Technologies LLC, San Francisco, CA (US)

(21) Appl. No.: 19/244,161

(22) Filed: Jun. 20, 2025

Related U.S. Application Data
(60) Provisional application No. 63/662,203, filed on Jun. 20, 2024.

(51) Int. Cl. G06F 16/435; G06F 16/432; G06F 16/487; G06F 40/295

(52) U.S. Cl. CPC G06F 16/435; G06F 16/432; G06F 16/487; G06F 40/295

(57) ABSTRACT

Methods and systems for providing and recommending geographically linked audio-visual experiences from cultural institutions are specified. Cultural institutions will utilize the item preservation subsystem to digitize items from their collections and related documents. The item preservation subsystem also provides insight regarding operating conditions within the organization. A content-visitor matching subsystem is used to create geographically based audio-visual compilations based on catalogued items. Users may search for compilations provided by cultural institutions within a geographic region. For each search, the content-visitor matching subsystem ranks and recommends nearby compilations from cultural institutions. The content-visitor matching subsystem also provides insight regarding conditions external to the organization that might impact visitor travel. A media matching subsystem enables cultural institutions to supplement their existing media with similar media provided by contributors. The media matching subsystem also enables supplementary media to be created based on text descriptions or existing media.

### RELATED APPLICATION

This application claims benefit of priority to U.S. Provisional Patent Application No. 63/662,203, filed Jun. 20, 2024; the aforementioned application being incorporated by reference in its entirety.

### BACKGROUND

Cultural institutions are often tasked with preserving items of historic or cultural significance and making them available to the public, who might be interested in them for education, recreation, research, or other purposes.

Cultural institutions often use dedicated software to digitally manage the cataloging and periodic inventory of items in their collections. They may also use software that enables items from their collections to be shared digitally with the public.

Despite the use of these systems, narrow insights and constrained resources often limit the ability to efficiently manage many items of historic and cultural significance, which might be stored in one of multiple geographic locations.

Despite the use of these systems, it can also be challenging for cultural institutions to share items and their context with interested groups and individuals. Cultural institutions often have interesting items within their collections, but might not have any additional content, context, or supplementary items that could help to fully capture the significance of the item and convey that significance to potentially interested visitors.

Conversely, it can be challenging for interested groups and individuals to find items and or institutions that they may be interested in learning more about. Interested visitors also might not have time to browse items and context at the institution or in the digital format that the institution has provided.

### BRIEF SUMMARY OF THE INVENTION

The system described herein encompasses three subsystems; it contains an item preservation subsystem, a content-visitor matching subsystem, and a media matching subsystem.

The item preservation subsystem improves data analysis by enabling cultural institutions to get actionable statistics related to the preservation of their items. In one embodiment, the item preservation subsystem makes use of manually entered data, sourced data, statistical methods, and frameworks for querying data with text, enabling users to receive notifications about meaningful changes in their data then subsequently ask questions about the organization.

The content-visitor matching subsystem enhances discoverability of content by enabling cultural institutions to share items along with context digitally in various audio-visual formats. In one embodiment, a user within a cultural institution can catalog an item of historic or cultural significance in the system, upload media related to the item, then present disparate yet related items as an audio-visual presentation that visitors can experience when in a selected geographic location.

The content-visitor matching subsystem also enhances discoverability by enabling interested groups and users to find institutions that have content related to the subject matter and time periods that they wish to learn more about. In one embodiment, the content-visitor matching subsystem makes use of existing geographically linked audio-visual experiences, prior searches, user preferences, and a statistical model, herein referred to as the content recommendation model, to rank and recommend audio-visual compilations to users within a geographic region.

In another embodiment, a statistical model, herein referred to as the visitor forecast model, enables operators of cultural institutions to receive visitor insights and recommendations which help them to optimize their combination of audio-visual compilations and promotional activities.

The media matching subsystem enhances discoverability by enabling individuals or institutions that have static images, moving images, or audio that is of historic and or cultural significance to potentially collaborate with one another in creating geographically linked experiences. An individual or entity that owns a piece of media—a media contributor, can make it available for collaborative use. A statistical model, herein referred to as the media matching model, enables an individual or entity that is looking for supplementary media—a media requestor, to search for, or receive notifications for available media that is similar to their media. Ultimately, media requestors are able to create geographically linked audio-visual experiences using relevant media from one or more media contributors found through use of the media matching model.

The media matching subsystem also enhances preservation efforts by assisting cultural institutions with creating media required for adding context to items within its collection. In one embodiment, the media matching subsystem makes use of saved static images, saved moving images, computer vision models, and image creation models to create three-dimensional versions of physical objects from the cultural institution's collection.

The summary and detailed description do not include all features. Additional features and improvements will be clarified upon review of the drawings and claims.

### BRIEF DESCRIPTION OF THE DRAWINGS

FIG. 1 is a system diagram of the main system and its three subsystems;

FIG. 2 is a system diagram for an example of the item preservation subsystem;

FIG. 3 is a block diagram illustrating the various modules and data stores within the item preservation subsystem;

FIG. 4 is an illustration of a class diagram for the item preservation subsystem;

FIG. 5 illustrates an example method for notifying cultural institution users of changes in their data then providing answers to spoken or typed questions;

FIG. 6 illustrates several instances of the preservation procedure class;

FIG. 7 illustrates an example of a user interface used to add or edit items in the item preservation subsystem;

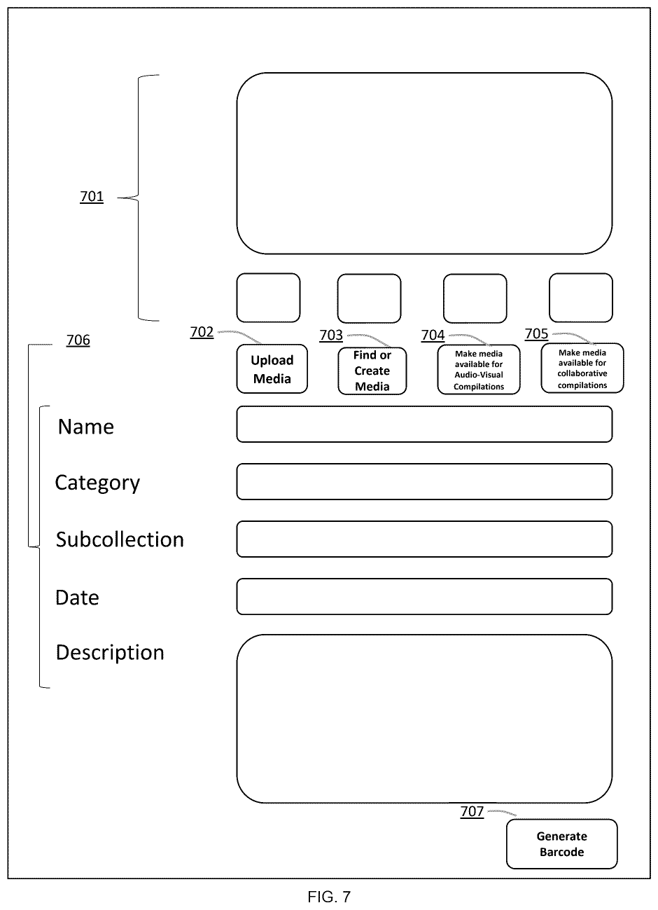

FIG. 8 is an illustration of an example user interface used to analyze information contained in the item preservation subsystem;

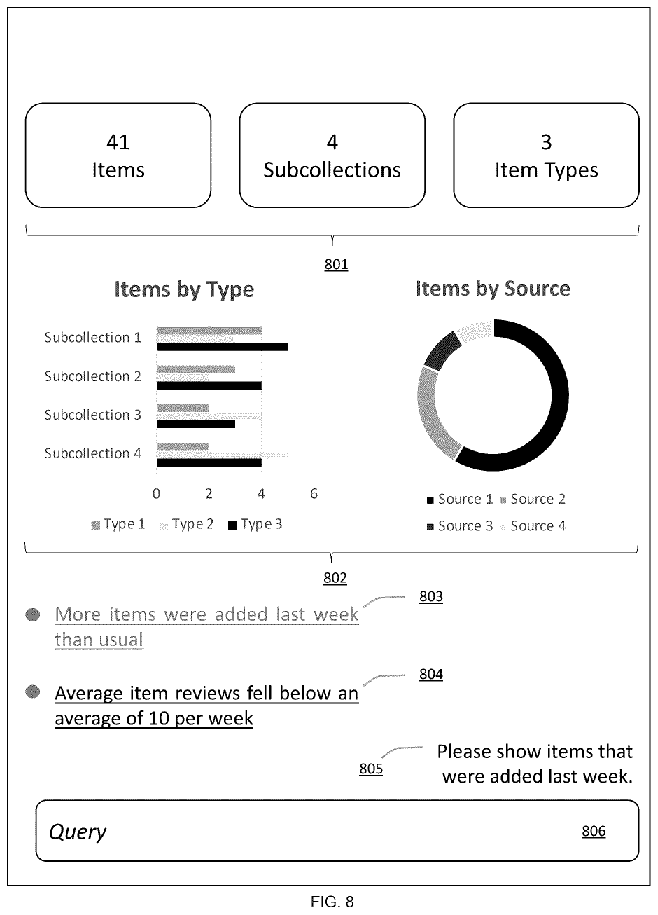

FIG. 9 is a system diagram for the content-visitor matching subsystem;

FIG. 10 is a block diagram illustrating the various data stores, logs, and modules within the content-visitor matching subsystem;

FIG. 11 is an illustration of a class diagram for the content-visitor matching subsystem;

FIG. 12 illustrates an example method for using media related to items within a collection to create a geographically based audio-visual compilation within a structure, outdoors, or regionally;

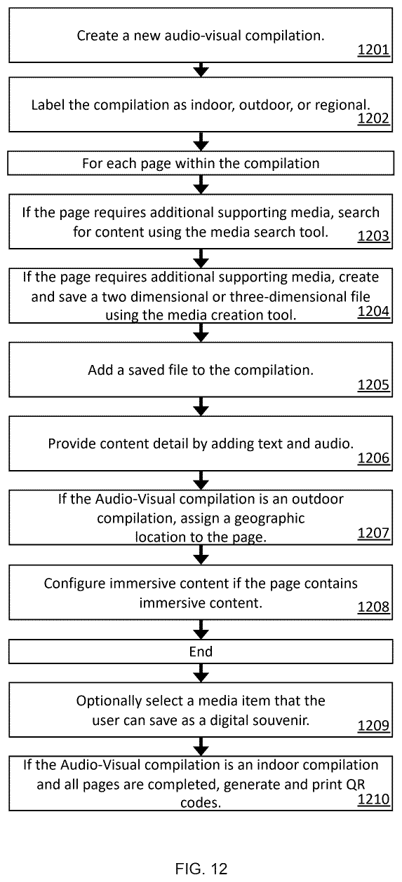

FIG. 13 illustrates an example of a user interface used to create new geographically based audio-visual compilations inside of a structure, at various outdoor checkpoints, or within an entire geographic region;

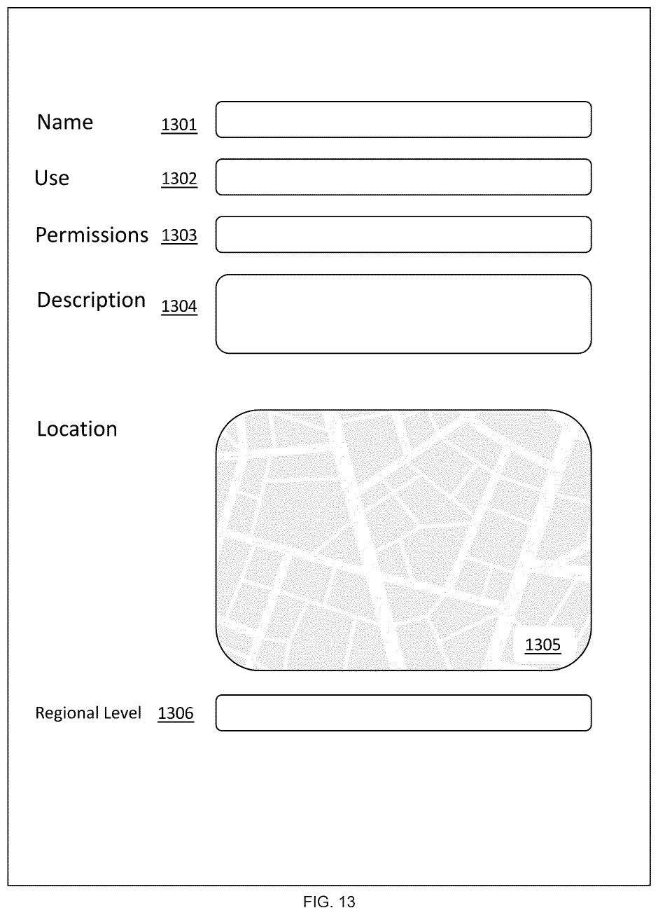

FIG. 14 illustrates an example of a user interface used to create a page or checkpoint for an audio-visual compilation located inside of a structure;

FIG. 15 illustrates an example of a user interface used to create a page or checkpoint for an audio-visual compilation located outdoors;

FIG. 16 illustrates an example of a user interface used to create a page or checkpoint for an audio-visual compilation associated with a geographic region;

FIG. 17 illustrates an example of a user interface for cultural institution users to view all audio-visual compilations created by their institution;

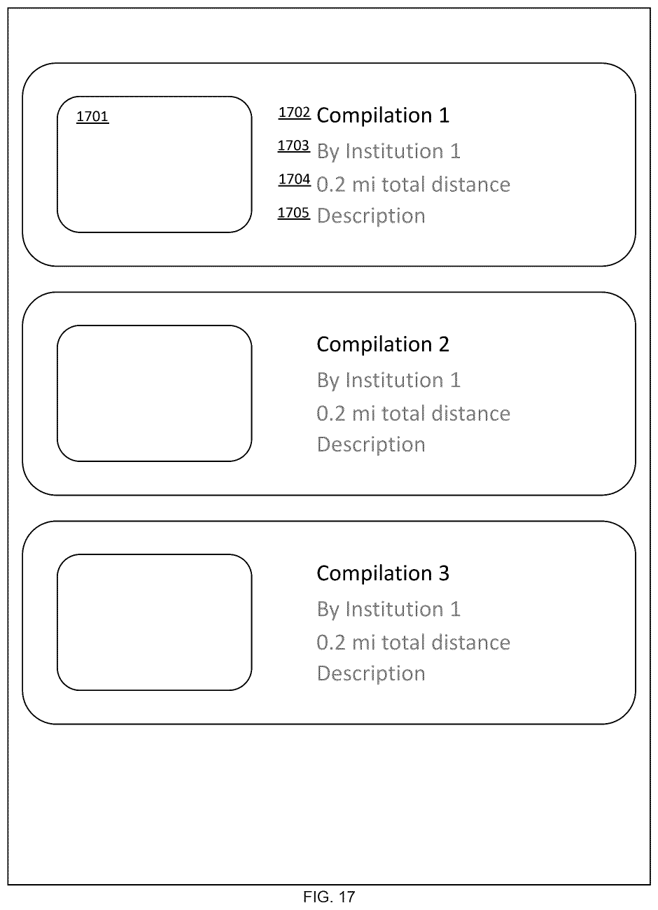

FIG. 18 illustrates an example method for enabling searches of audio-visual compilations created by cultural institutions;

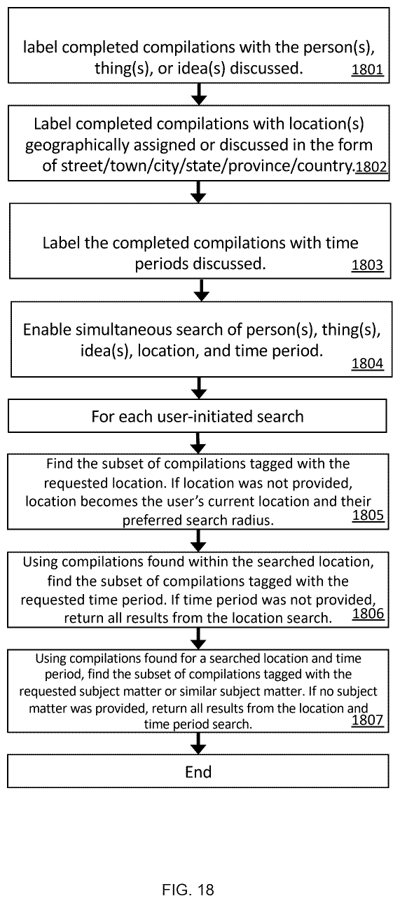

FIG. 19 illustrates an example of a user interface for visitors to search for all audio-visual compilations that exist within a specified geographic area and meet a given search criteria;

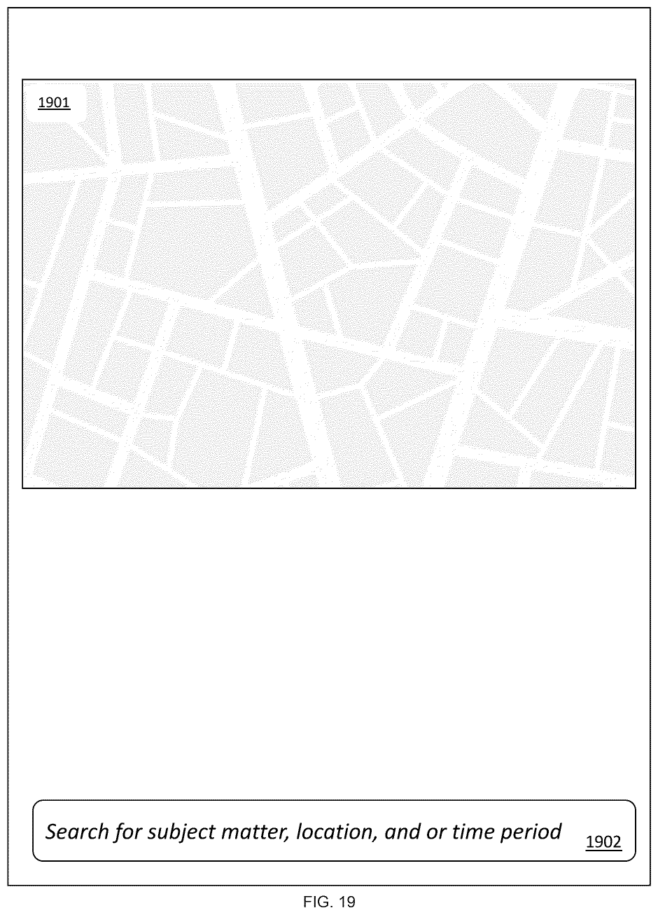

FIG. 20 illustrates an example method for ranking and recommending audio-visual compilations created by cultural institutions;

FIG. 21 illustrates an example of a user interface for visitors to view and sort search results for audio-visual compilations that exist within a specified geographic area and meet a given search criteria;

FIG. 22 illustrates an example method for enabling users to select a search result and be guided through a geographically linked audio-visual experience;

FIG. 23 illustrates an example of a user interface for a visitor selecting an audio-visual compilation that has been presented as part of a search result from the content-visitor matching subsystem;

FIG. 24 illustrates an example method for forecasting changes in visitors to locations associated with a cultural institution then providing relevant recommendations;

FIG. 25 illustrates an example of a user interface used to view visitor forecasts and recommendations;

FIG. 26 is a system diagram for an example of the media matching subsystem;

FIG. 27 is a block diagram illustrating the various data stores, logs, and modules within the media matching subsystem;

FIG. 28 is an illustration of a class diagram for the media matching subsystem;

FIG. 29 illustrates an example method for media requestors with items of historic or cultural significance to find and use similar or related content from media contributors through use of the media matching subsystem;

FIG. 30 illustrates an example method for determining the level of similarity between media files in the media matching subsystem;

FIG. 31 illustrates an example of a user interface that enables media requestors to be notified of available contributed media that is similar to their provided reference media;

FIG. 32 illustrates an example method for cultural institutions to create media that adds context to existing media by using the media matching subsystem; and

FIG. 33 illustrates an example of a user interface that enables text-based search for contributed content in the media matching subsystem.

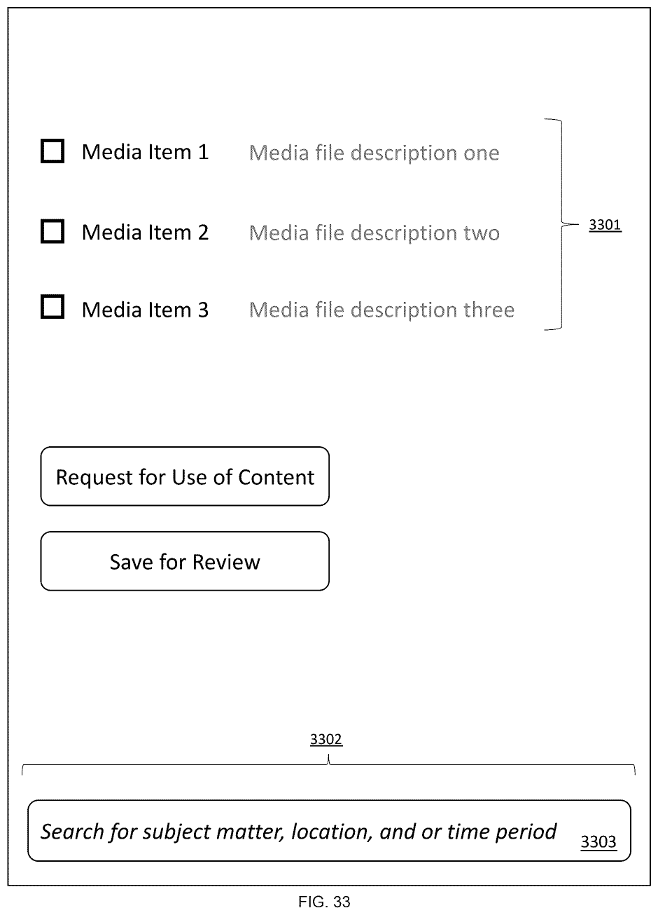

### DETAILED DESCRIPTION

### System Overview

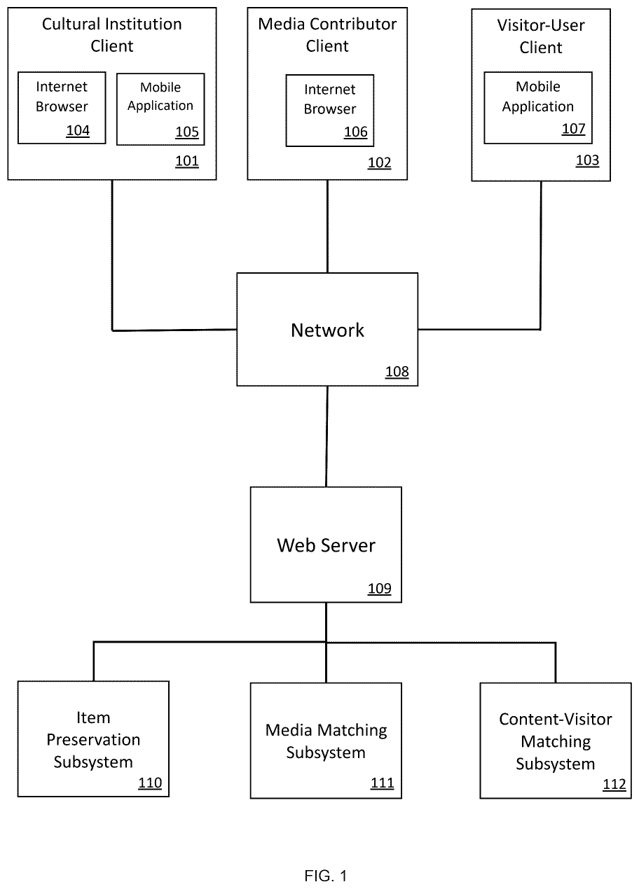

Referring to FIG. 1, the network 108 enables computing communication between cultural institutions 101 and the item preservation subsystem 110. The network 108 enables computing communication between cultural institutions 101, visitor-users 103, and the content-visitor matching subsystem 112. The network 108 enables computing communication between cultural institutions 101, media contributors 102, and the media matching subsystem 111.

The web server 109 contains data and logic that enables cultural institutions 101 to connect to the subsystems through the internet using a desktop browser 104 or through an application installed on a mobile computing device that has internet connectivity, camera, microphone, and enabled GPS 105. The web server 109 enables media contributors 102 to connect to the media matching subsystem 111 through an internet browser 106. The web server 109 also enables visitor-users 103 to access the content-visitor matching subsystem 112 using a mobile computing device with internet connectivity, camera, audio output capability, and enabled GPS 107.

The system's main functions, which are to preserve items, to find and match similar media, and to share content, correspond to the three subsystems described below.

The item preservation subsystem 110 enables cultural institutions to create or digitize records related to items in their possession. The item preservation subsystem 110 also enables a cultural institution's users to ask for data, analysis, or recommendations related to their data vocally or by using text.

The media matching subsystem 111 takes media or context provided by requestors and recommends similar media from contributors. The media matching subsystem 111 also takes media or context provided by requestors and creates two-dimensional items, three-dimensional items, or immersive scenes composed of two-dimensional and or three-dimensional items.

The content-visitor matching subsystem 112 provides tools for cultural institutions to create audio-visual compilations using media from their collections. The content-visitor matching subsystem 112 also recommends audio-visual compilations created by cultural institutions to individual users.

### Item Preservation Subsystem

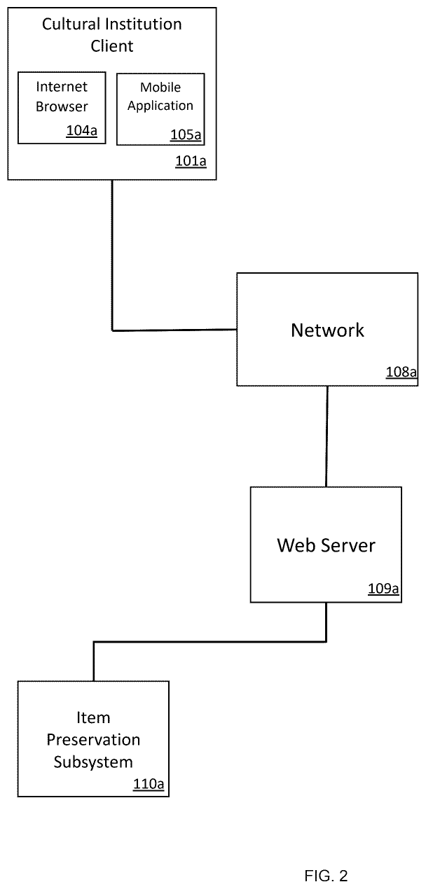

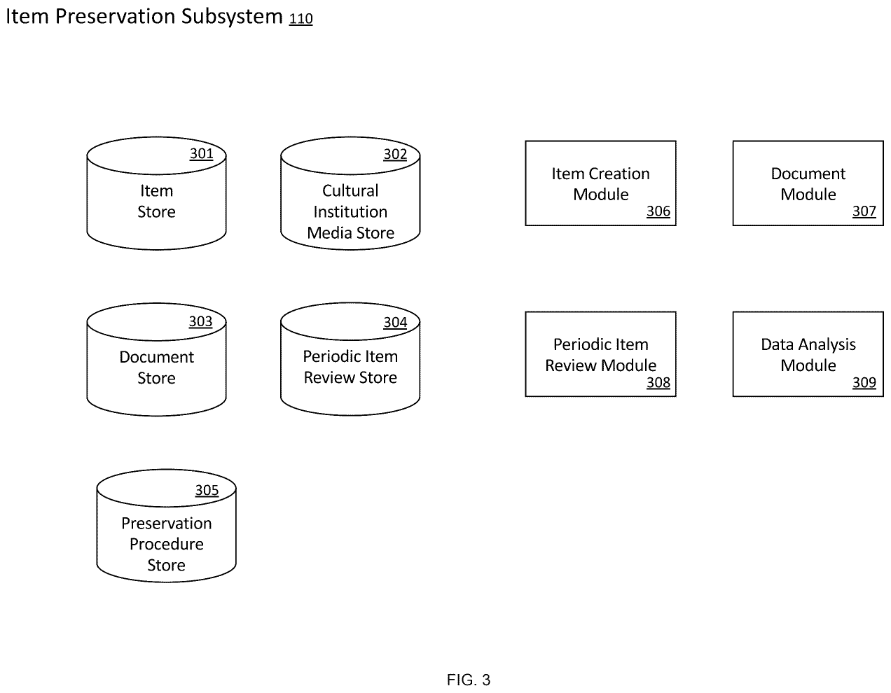

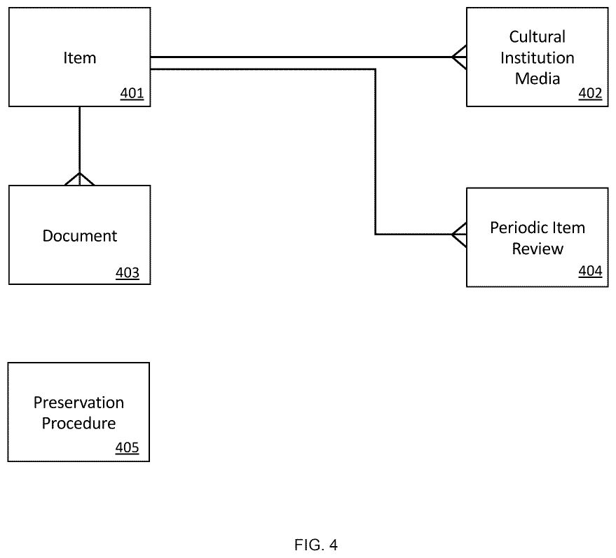

Referring to FIG. 2, FIG. 3, and FIG. 4, cultural institutions 101a are the only users of the item preservation subsystem 110a. This system enables cultural institutions to digitize items and records belonging to their collections either through a web browser installed on a computing device 104a or through a mobile application installed on a mobile computing device 105a. The item preservation subsystem 110a contains various components which are described below.

The item store 301 contains data describing items that a cultural institution has chosen to catalog within the item preservation subsystem 110a through use of the item creation module 306. Each item is represented by an instance of the item class 401, which contains attributes related to the documented item such as name, acquisition source, place of origin, date of origin, in addition to other attributes.

The item preservation subsystem's 110a cultural institution media store 302 contains data describing digitized audio, static images, or moving images that a cultural institution has chosen to store within the system while using the item creation module 306. Each audio-visual file is represented by an instance of the cultural institution media class 402, which contains attributes and metadata related to the file such as name, size, date created, and format.

The document module 307 is used by cultural institutions to add and edit documents related to items within a collection. Such documents may be associated with the acquisition of an item or insurance coverage for an item. The document store 303 contains data describing these documents. Every document is represented by an instance of the document class 403, which contains attributes summarizing the purpose of the document and the item that the document is associated with.

The periodic item review module 308 is used when a cultural institution wants to verify the presence of and assess the condition of items from its collection. The periodic item review store 304 contains data describing an item review event. An item review event is represented by an instance of the periodic item review class 404, which contains attributes related to the review such as date started, participants, and whether the review is for all or some of a cultural institution's items.

The preservation procedure store 305 contains data describing processes used by cultural institutions, associated issues, and known solutions. Each procedure is represented by an instance of the preservation procedure class 405, which contains attributes related to a process such as but not limited to name, description, step, reason, measurability, metric, unit of measurement, frequency, value, irregularity, and recommendation.

The data analysis module 309 is used to review statistics and answer questions related to items, media, documents, or periodic item reviews.

The item preservation subsystem's 110a item store 301, cultural institution media store 302, document store 303, periodic item review store 304, and preservation procedure store 305 described above require database management systems for writing and reading data.

The item preservation subsystem described herein uses a cloud-based implementation and client-server architecture. Other configurations for implementation are also possible. The item preservation subsystem 110a may also contain other stores, logs, and modules not represented here. Other parts of the system related to user authentication, network management, and firewalls are not material to the invention and therefore are not shown.

### Item Preservation Subsystem—Item Preservation Recommendations and Queries

The data analysis module 309 enables cultural institution users 101a to receive notifications for metrics related to items added to the organization, items removed from the organization, media added, documents added, and periodic item reviews.

After a cultural institution user 101a selects the desired metrics, notifications are received on the cultural institution client 101a device containing the mobile application 105a.

The preservation procedure store 305 contains data describing processes used by cultural institutions, associated issues, and known solutions. Each procedure is represented by an instance of the preservation procedure class 405, which contains attributes related to a process such as but not limited to name, metric, condition, value, unit of measurement, irregularity, action, and recommendation. These attributes are used to generate a recommendation given an irregularity in a preservation process or its metrics.

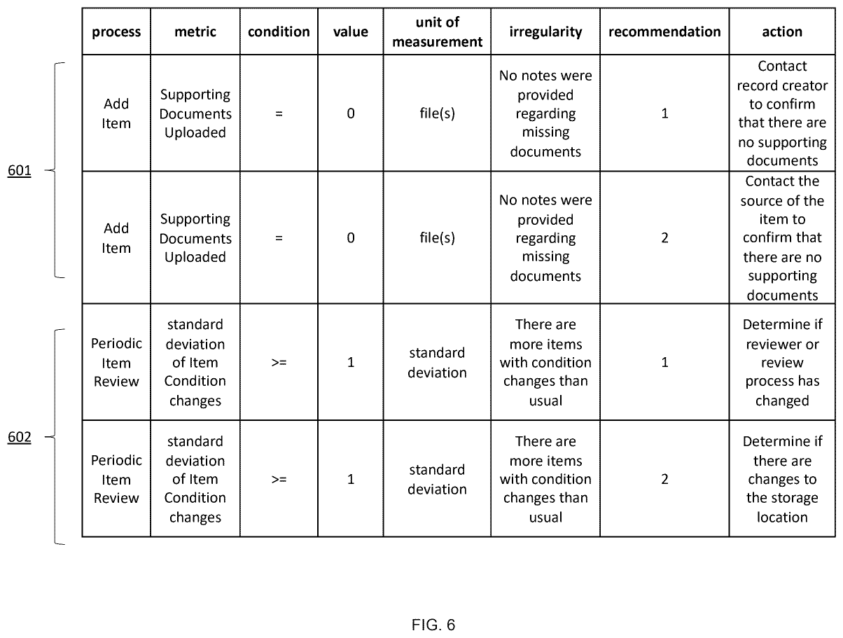

FIG. 6 contains examples of several preservation procedure objects. The preservation procedure objects 601 describe what actions should be taken if an item was added to a collection, but it has no associated documents such as acquisition receipts or insurance policies and there are also no notes specifying why. In such instances, the first recommended action is to contact the individual who added the item to determine why there aren't any associated documents. The second recommended action is to contact the source of the item to confirm that there are no supporting documents.

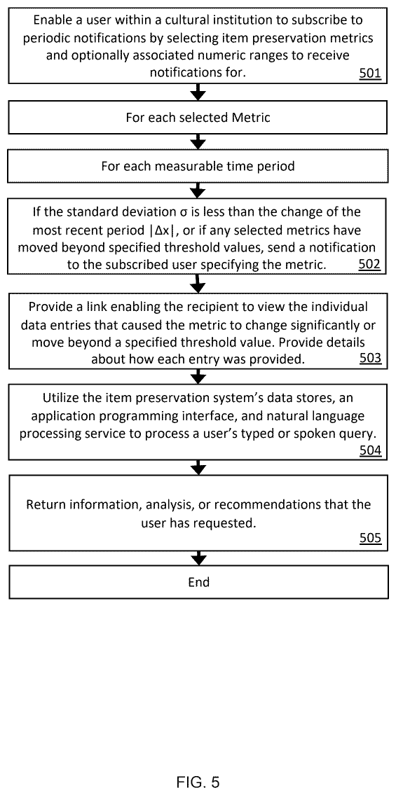

FIG. 5 shows a flowchart of a process for sending notifications to a cultural institution user regarding metrics that they have subscribed to.

Users within a cultural institution can use the data analysis module 309 to view summary data 801 and charts 802 related to item preservation activity. In one embodiment, a cultural institution user 101a is able to select certain data points for which they'd like to receive notifications. For example, a cultural institution user 101a can select one or more metrics such as items added, items removed, media added, documents added, and or periodic item reviews. By selecting one or more metrics, a user opts to receive notifications and will be notified of statistically significant changes in values of item preservation metrics over predetermined time periods such as days, weeks, months, quarters, or years.

For each metric that the cultural institution user 101a requests to receive notifications for, for each measurable period (e.g. day, week, month, quarter, year) the data analysis module 309 computes the absolute value of the difference between the most recent period's value and the value from two prior periods, |Δx|. For example, if the value for the items added metric was 25 at the end of day 1, and was 20 at the end of day 2, |Δx| will be 5 at the start of day 3.

The item preservation subsystem 110a uses all of the metric's prior periodic values to compute a standard deviation for the periodic metric, σ. This measures how far from the average a metric tends to be. For example, if on average, 5 items are removed daily, and the items removed metric consistently is 3, 5, or 7, σ of items removed will be 2.

If the standard deviation σ of a given metric is less than the change of the most recent period |Δx|, it is assumed that the metric's most recent change is abnormal, and a notification is sent to the user via the application 803.

For each metric that the cultural institution user 101a requests to receive notifications for, the data analysis module 309 repeats the process for each measurable time period, computing the periodic change in the metric, |Δx| (e.g. change in weekly items added, change in monthly items added, etc.) and the periodic standard deviation for the metric, σ (e.g. standard deviation for weekly items added, standard deviation for monthly items added, etc.). For all computed periods, if the standard deviation σ of the periodic metric is less than the change of the most recent period |Δx|, a notification is sent to the user via the application.

As an example, if a user opts to receive notifications for items added to the organization, at the start of a new period such as a new week, the data analysis module 309 will send a notification to the cultural institution user if the weekly standard deviation σ_{w} for items added to the organization is less than the change in items added during the past week |Δx|_{w}. If the current date is the start of a new calendar period such as month, the data analysis module 309 will send a notification to the cultural institution user if the monthly standard deviation σₘ for items added to the organization is less than the change in items added during the past month |Δx|ₘ. If the current date is the start of a new calendar period such as quarter or year, the data analysis module repeats the process for the period and sends notifications if necessary.

In one embodiment, if the situation presented in the notification is modeled in a preservation procedure object, a recommendation is generated with the notification. As an example, a user can subscribe to notifications for significant changes in item condition then receive a notification if more items than usual have changed from “good” to “fair” condition. The preservation procedure class 405 has modeled several instances of this situation 602 and will recommend checking if the reviewer or the review process has changed. It will also recommend checking the conditions in the storage location.

In another embodiment, if the situation presented in the notification has not been modeled in the preservation procedure store 305, the item preservation system can prompt the user to provide details about the irregularity and to provide a recommended action. The provided recommendation will be presented to a user if conditions cause the notification to be sent again.

In addition to selecting metrics to receive automated notifications for, a cultural institution user 101a can select a custom combination of period, metric, operator, and numeric threshold for which they want to receive notifications. As an example, a user can specify that they want to receive a notification if the daily (period) count of items added to the organization (metric) is less than (operator) two (numeric threshold). The operators that a user can select include but are not limited to less than (<), greater than (>), equal to (=), less than or equal to (<=), and greater than or equal to (>=).

In one embodiment, if the situation represented in the custom notification has not been modeled in a preservation procedure object, the user can add instances 601 602 describing the custom notification threshold (condition and value), what it means (irregularity), and how it can be resolved (recommendation and action).

If any of the custom metrics have moved above or below specified ranges, a notification is sent to the cultural institution user's mobile device via the application 804. The notification specifies the metric and the corresponding threshold which it met or exceeded.

The notification also contains a link that enables the recipient to view the individual data points that caused the metric to change significantly or move beyond a threshold value. Details are also shown regarding how the data points were entered into the item preservation subsystem 110a.

Upon receiving a notification for an item preservation metric, the data analysis query tool 806 can be utilized to type or verbally ask questions related to the changed metric. To respond to a user's question, any text that is typed or spoken must be converted into structured query language (SQL). Text based queries are first normalized by programmatically removing punctuation before converting the query to SQL. For example, the text-based query “Please show the items that were added last week” might be normalized by removing the third word “the”.

The conversion to structured query language (SQL) is achieved by using a custom trained named entity recognition model. Such models can be used to map commonly used words to the entities of the item preservation subsystem 110a. For example, if the user types or speaks the query “Please show items that were added last week”, the trained named entity recognition model would infer that the words “items” refers to instances of the item class 401, “added” implies that a new entry was created and assigned a created_date, and that “last week” refers to a date.

The normalized query is then converted by the trained named entity recognition model to a form of SQL such as

SELECT * FROM items
WHERE created_date > = CURRENT_DATE − INTERVAL ‘7’ DAY

If a voice-based query was provided, the query is converted to text using a speech-to-text application programming interface such as AWS Transcribe, then normalized and converted to SQL using the named entity recognition model.

The raw data returned from the query is formatted for readability and is also converted into conversational text using an application programming interface for accessing natural language processing features of a text generation model.

The formatted data and conversational text responses are returned to the application then displayed to the user via the interface. If a voice-based query was used, a text-to-speech application programming interface is used to read the response to the user.

### Content-Visitor Matching Subsystem

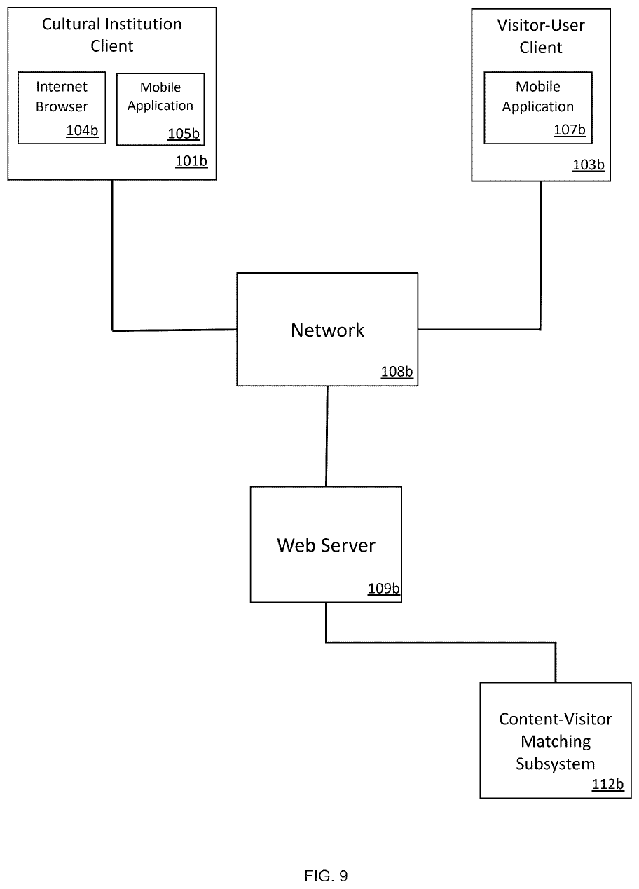

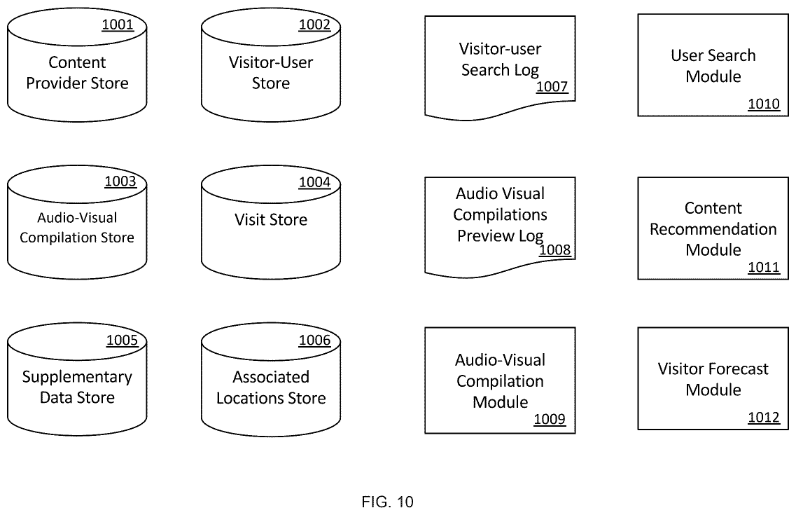

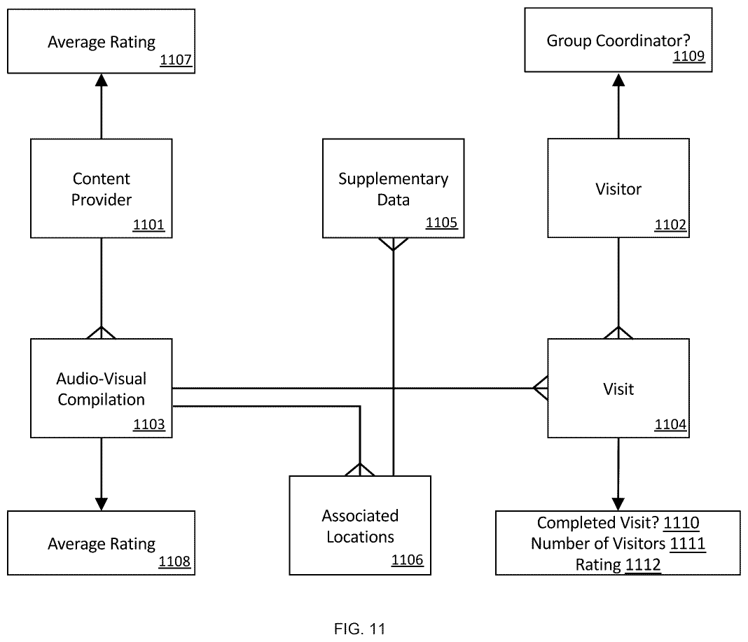

Referring to FIG. 9, FIG. 10, and FIG. 11, Cultural institutions 101b are one user of the content-visitor matching subsystem 112b. Cultural institutions 101b provide audio-visual content associated with geographic locations either through the internet via a computing device 104b or through a mobile application using a mobile device 105b.

Visitor-users 103b are another user of the content-visitor matching subsystem 112b. Visitor-users 103b search for audio-visual content based on location, person(s), object(s), or idea(s), and or time period using a GPS enabled mobile device with a screen and audio output capabilities 107b.

The content-visitor matching subsystem 112b provides visitors with a list of nearby audio-visual compilations sorted by relevance to their search. The content-visitor matching subsystem 112b contains various components which are described below.

The audio-visual compilations store 1003 contains data describing combinations of audio, video, images, and text that cultural institutions 101b have assembled, contextualized, geographically linked, and made available to visitor-users 103b by means of the audio-visual compilation module 1009. Each audio-visual compilation is represented by an instance of the audio-visual compilation class 1103, which contains various attributes related to the compilation, such as name, associated cultural institution, location, person(s), object(s), idea(s), time period(s), search keywords, associated date range, and rating 1108. The audio-visual compilation, which may contain media associated with multiple items from a collection, may be associated with multiple instances of the cultural institution media class 402 and consequently multiple instances of the item class 401.

The average rating attribute 1108 for an instance of the audio-visual compilation class 1103 is a weighted average of all ratings for the compilation with a decay factor applied to individual ratings based on when the rating was provided.

The content provider store 1001 contains data describing cultural institutions 101b that share audio-visual compilations with visitor-users 103b by using the audio-visual compilation module 1009. Each content provider is represented by an instance of the content provider class 1101, which contains various attributes related to the content provider, such as name, location, institution type, and rating 1107. A content provider may be associated with multiple instances of the audio-visual compilation class 1103.

The average rating attribute 1107 for every instance of content provider 1101 is a weighted average of ratings from all audio-visual compilations associated with the cultural institution. A decay factor is applied to the individual ratings based on when the rating was provided.

The visitor-user store 1002 contains data describing individuals that use the content-visitor matching subsystem 112b by means of a mobile application to find shared audio-visual compilations. Every visitor is represented by an instance of the visitor class 1102, which contains various attributes related to the user such as username, email address, other contact information, and a boolean attribute indicating whether or not the user is a group coordinator 1109.

The user search module 1010 is utilized by visitor-users to find content within a geographic area by person(s), object(s), idea(s), location, and or time period.

The content recommendation module 1011 takes as input a user generated search and displays search results that are ranked and sorted based on the likelihood of being rated highly by any user and by users who are similar to the visitor-user.

The visitor-user search log 1007 captures data about content searches performed by visitors 103b using the content-visitor matching subsystem 112b. The visitor-user search log 1007 contains information related to the search keywords, the search results returned, the approximate location of a user during the search, and the radius within which the results exist.

When search results are returned, all audio-visual compilations can be previewed. The audio-visual compilations preview log 1008 captures data about audio-visual compilations that were previewed after being presented as part of a search result. The audio-visual compilations preview log 1008 also contains information related to the search that resulted in content being previewed.

The visit store 1004 contains data describing visitor-users that used the content-visitor matching subsystem 112b by means of a search, then started an audio-visual compilation. Each visit is represented by an instance of the visit class 1104, which contains various attributes such as the associated visitor, the associated audio-visual compilation, the date of the visit, length of time to complete, and rating.

The completed visit attribute 1110 of a visit object indicates whether the audio-visual compilation was experienced in its entirety. One visitor 1102 may be associated with a visit, therefore multiple visitors who are part of a group will correspond to multiple instances of the visit class 1104. The number of visitors attribute 1111 of the visit class 1104 indicates for each visit, how many other visitors are present and part of the same group. The rating attribute 1112 for the visit class 1104 contains the rating provided by the user for the audio-visual compilation.

The supplementary data store 1005 contains global and local macroeconomic and event data. Data points are represented by instances of the supplementary data class 1105, which contains attributes such as but not limited to unique identifier, metric, date, value, and unit of measurement.

The associated locations store 1006 contains locations associated with an organization's audiovisual compilations, their cataloged items, and their physical location(s). Each associated location is represented by instances of the associated locations class 1106.

The visitor forecast module 1012 provides operators of cultural institutions with periodic recommendations and forecasts of visitors to a location associated with the organization's audiovisual compilations, their cataloged items, and or their physical location(s).

The content provider store 1001, visitor-user store 1002, audio-visual compilation store 1003, visit store 1004, supplementary data store 1005, associated locations store 1006, visitor-user search log 1007, and audio-visual compilations preview log 1008 described above require database management systems for writing and reading data.

The content-visitor matching subsystem 112b described above uses a cloud-based implementation and client-server architecture. Other configurations for implementation are also possible. The content-visitor matching subsystem 112b may also contain other stores and logs not represented here. Other parts of the system related to user authentication, network management, and firewalls are not material to the invention and therefore are not shown.

### Content-Visitor Matching Subsystem—Audio-Visual Compilation Methodology

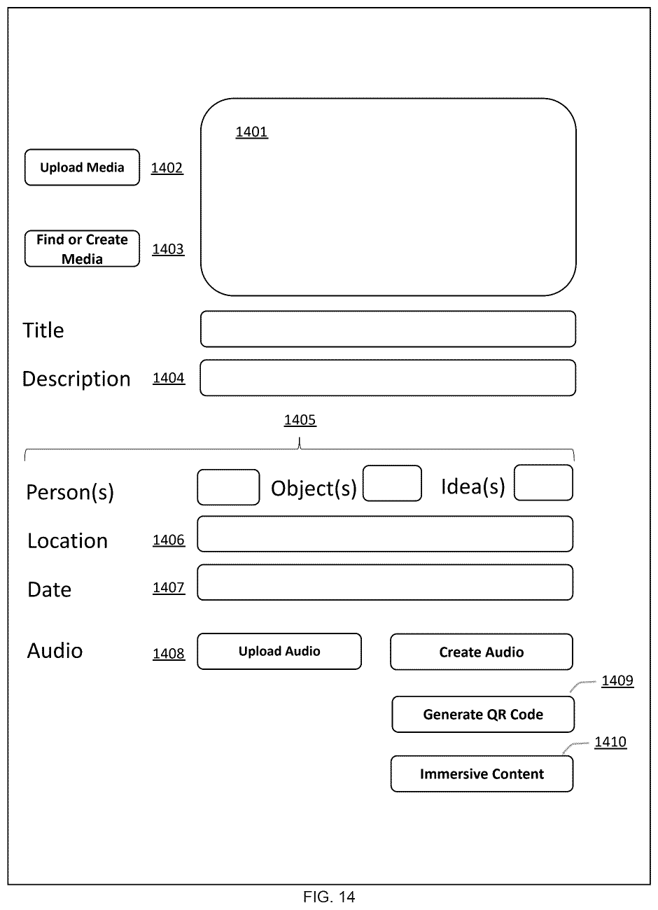

FIG. 14, shows an exemplary embodiment of a user interface that enables a cultural institution user to create an audio-visual compilation indoors.

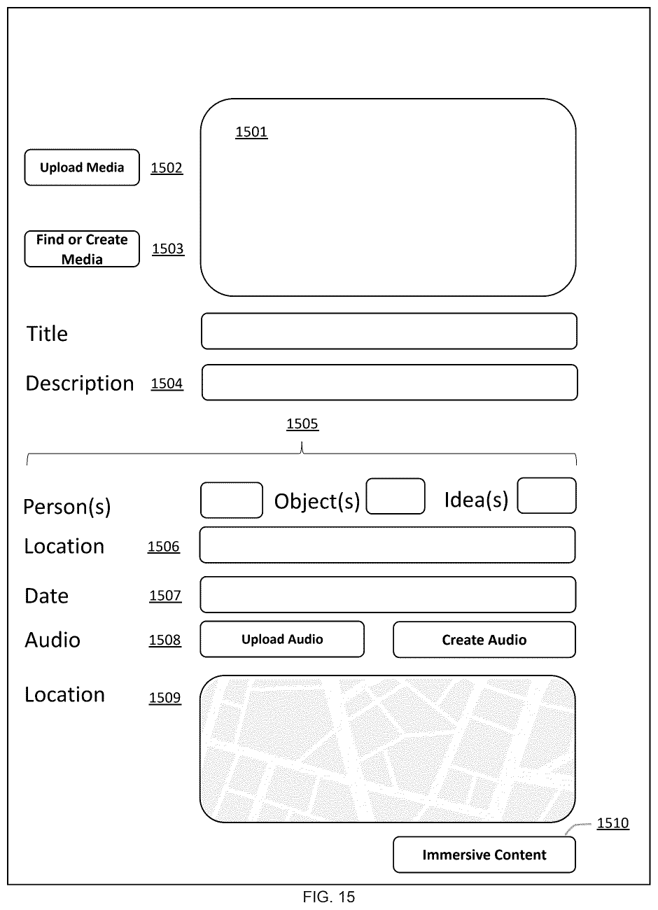

FIG. 15, shows an exemplary embodiment of a user interface that enables a cultural institution user to create an audio-visual compilation outdoors.

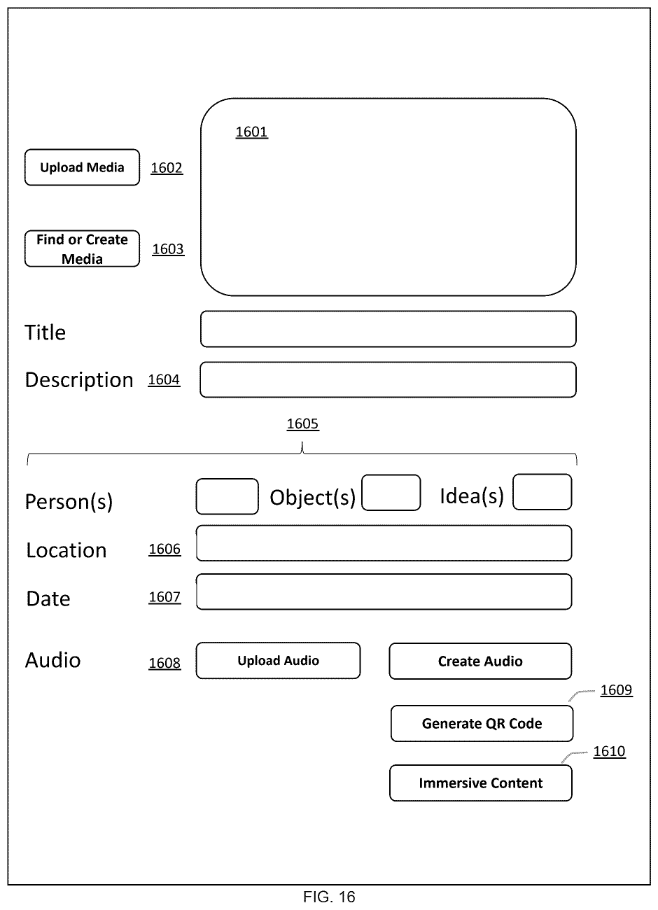

FIG. 16, shows an exemplary embodiment of a user interface that enables a cultural institution user to create an audio-visual compilation for an entire geographic region.

The content-visitor matching subsystem 112b can be used by cultural institutions to create geographically linked audio-visual experiences, herein referred to as audio-visual compilations. Audio-Visual compilations are provided with a name 1301 and labeled as intended for indoor, outdoor, or regional use 1302. Permissions 1303 are provided to specify whether the compilation is for all application users or for a specific subset of users. As an example, permissions for an audio-visual compilation could be limited to members of a cultural institution that use the mobile application.

An indoor audio-visual compilation is associated with a single geographic location 1305.

Indoor audio-visual compilations are comprised of pages, each of which contains a media item 1401, subject matter which can include person(s), object(s), idea(s) 1405, location 1406, and date or time period 1407.

In one embodiment, QR codes 1409 are generated and printed to guide users through the experience and its checkpoints, which correspond to the pages of an indoor audio-visual compilation.

An outdoor audio-visual compilation is associated with one or more geographic locations 1509, each of which are associated with one or more pages of the compilation.

Outdoor audio-visual compilations are comprised of pages, each of which contains a media item 1501, subject matter which can include person(s), object(s), idea(s) 1505, location 1506, and date or time period 1507.

After each page of an outdoor audio-visual compilation is experienced, the user is provided with GPS-based directions to the subsequent geographic checkpoint or page associated with the compilation.

A regional audio-visual compilation is associated with an entire geographic region such as a country, province, state, or town. A regional audio-visual compilation can be accessed and experienced from anywhere within a region and is not necessarily associated with multiple geographic checkpoints.

Regional audio-visual compilations are comprised of pages, each of which contains a media item 1601, subject which can include person(s), object(s), idea(s) 1605, location 1606, and date or time period 1607.

After each page of a regional audio-visual compilation is experienced, the user is able proceed to the subsequent page of the audio-visual compilation without necessarily requiring another QR code or directions to the subsequent geographic checkpoint.

For each page of an indoor, outdoor, or regional audio-visual compilation, audio-visual compilation creators can use the upload media functionality 1402 1502 1602 to load media associated with items catalogued within the item preservation subsystem 110.

For each page of an indoor audio-visual compilation, media items can be presented relative to real world objects using the immersive content tool 1410. In one embodiment, a cultural institution user can utilize the immersive content tool 1410 to display two-dimensional images (in a format such as.png, jpg), videos (in a format such as.mp4), and or three-dimensional objects (in a format such as.obj,.fbx, glb,.usdz) relative to real world objects. The cultural institution user's mobile application 105b is used to import selected image(s), video(s), and or three-dimensional object(s) into an augmented reality framework such as Unity, ARKit, or ARCore, where they are configured for lighting and shadows then assigned visual scale and a reference image which will be printed. When a visitor user is guided through an indoor audio-visual compilation, they are notified if a checkpoint contains immersive content. A visitor user client device 103b can utilize an augmented reality framework from their application 107b and the device's camera to detect the printed reference image. The two-dimensional image(s), video(s), and or three-dimensional object(s) will appear over the printed reference image when viewed from the visitor user client's screen 103b.

For each page of an outdoor audio-visual compilation, media items can be presented relative to real world objects using the immersive content tool. In one embodiment, a cultural institution user can utilize the immersive content tool 1510 to display two-dimensional images (in a format such as.png, jpg), videos (in a format such as.mp4), and or three-dimensional objects (in a format such as.obj,.fbx,.glb,.usdz) relative to real world objects. The cultural institution user's mobile application 105b is used to import selected image(s), video(s), and or three-dimensional object(s) into an augmented reality framework such as Unity, ARKit, or ARCore, where they are configured for lighting and shadows then assigned visual scale, latitude, longitude, and geographic heading. When a visitor user is guided through an outdoor audio-visual compilation, they are notified if a checkpoint contains immersive content. In one embodiment, a visitor-user client device 103b utilizes the device's GPS, magnetometer, and accelerometer to detect the user's latitude, longitude, and heading. A visitor-user client device 103b then uses an augmented reality framework from their application 107b to display the immersive content (two-dimensional image(s), three-dimensional object(s), and or video(s)) relative to the visible environment when the device's screen and camera are oriented towards the latitude, longitude, and heading assigned to the content.

For each page of an indoor, outdoor, or regional audio-visual compilation, if the page requires supporting media that is not available in the item preservation subsystem 110, audio-visual compilation creators can use the find media functionality 1403 1503 1603 to find media made available by contributors that are similar to the cultural institution's media. If a media item is found that the cultural institution would like to use, the cultural institution can digitally sign an agreement with contributors regarding use, copyright, and attribution.

For each page of an indoor, outdoor, or regional audio-visual compilation, if additional context is required but there are no usable media items, audio-visual compilation creators can use the create media functionality 1403 1503 1603 to create static or moving images based on existing media or context descriptions.

For each page of an indoor, outdoor, or regional audio-visual compilation in which a supplementary media file was found or created, audio-visual compilation creators can add the media file to the page.

For each page of an indoor, outdoor, or regional audio-visual compilation, audio-visual compilation creators can provide content detail to the page by adding text 1404 1504 1604 and audio 1408 1508 1608.

For each page of the compilation, if the audio-visual compilation is an outdoor compilation, audio-visual compilation creators can assign a geographic location 1509 to the page which serves as a geographic checkpoint for the user.

Audio-visual compilation creators can add subsequent pages to the compilation, providing relevant media 1401 1501 1601, text 1404 1504 1604, audio 1408 1508 1608, and geographic locations 1305 1306 1509 until all pages are completed.

If the audio-visual compilation is an indoor compilation and the creation of pages is complete, audio-visual compilation creators can generate and print QR codes 1409 which visitor-users can scan to start experiencing a page.

For all compilations, an optional media item can be added that a visitor-user can save as a digital souvenir. If the digital souvenir was originally presented as immersive content or is a 3D object, the visitor-user client uses the mobile device's accelerometer, magnetometer, camera, and an augmented reality framework within their application 107b to detect surfaces such as walls or tabletops on which to present the digital souvenir.

For each audio-visual compilation, any person, thing, idea, location, or time period found in the title 1301, location 1305 1509, or content description 1304 can be used to improve searches.

For each page of an indoor, outdoor, or regional audio-visual compilation, any person, thing, idea 1405 1505 1605, place 1406 1506 1606, and or time period 1407 1507 1607 that is associated with media files 1401 1501 1601 is associated with the audio-visual compilation and can be used to improve searches.

For each page of an indoor, outdoor, or regional audio-visual compilation, any person, thing, idea, place, and or time period found in the text description 1404 1504 1604 or audio description 1408 1508 1608 is associated with the audio-visual compilation and can be used to improve searches.

For each page of an indoor, outdoor, or regional audio-visual compilation, each media file 1401 1501 1601 is associated with an item cataloged in the item preservation system 110. Any inscriptions, creators, or provenance notes 706 associated with the underlying cataloged item will be associated with the audio-visual compilation and can be used to improve searches.

Improving searches of audio-visual compilations based on provided labels is achieved through the use of trained named entity recognition models. Such models are used to map commonly used words to entities, in this case to search categories, and more specifically person, object, idea or concept, location, and time period. The title, location, and description of the compilation, the text descriptions and labeled media from each page of the compilation, the inscriptions, creator(s), and provenance notes associated with underlying cataloged items are passed to the trained named entity recognition model using an application programming interface, then mapped appropriately to the audio-visual compilation's person(s), object(s), idea(s) or concept(s), location, and time period.

### Content-Visitor Matching Subsystem—Content Recommendation Model

Audio-visual compilations are labeled with the person(s), thing(s), or idea(s) discussed within its pages.

Audio-visual compilations are labeled with location(s) that can include the street, town, city, state, province, and or country that is discussed within its pages.

Audio-visual compilations are labeled with a time period or time periods that are discussed within its pages.

Visitor-users 103b can utilize the search tool 1902 to simultaneously search for person(s), thing(s), idea(s), location, and or time period.

Given search criteria containing person(s) and or thing(s) and or idea(s) and or location and or time period, the content-visitor matching subsystem 112b finds the subset of compilations associated with the requested location and surrounding areas within a user's preferred search radius. If a location was not provided, the location searched becomes the user's current geographic location as determined by GPS.

Using compilations found within the searched location, the content-visitor matching subsystem 112b finds the subset of compilations labeled with the requested time period. If time period was not provided, all results from the location search are used.

Using compilations found for a searched location and time period, the content-visitor matching subsystem 112b finds the subset of compilations labeled with the requested subject matter (person(s) and or thing(s) and or idea(s)) or similar subject matter. If no subject matter was provided, all results from the location and time period searches are used.

The search tool 1902 enables simultaneous search for person(s), object(s), idea(s), location, and time period through the use of trained named entity recognition models. Such models can be used to map commonly used words to entities, in this case to search categories, specifically person, object, idea or concept, location, and time period. The search results are passed to the trained named entity recognition model using an application programming interface, then mapped to the appropriate search category. In one embodiment, if an unrecognized search term is found, a user may be prompted to categorize the term as being a person, object, idea or concept, location, or time period.

For a given geographic region with a plurality of audio-visual compilations, the content recommendation module 1011 creates and uses a statistical model to estimate for any visitor-generated search 1902, the likelihood that found geographically linked audio-visual compilations 2103 will be rated highly by any visitor and will also be rated highly by similar visitors. Similar requestors are defined as other users with similar profiles and content preferences. For example, similar users could be several individuals who are all frequent users, group coordinators for groups of two to ten visitors, and visitors of sports museums. The computed likelihoods are combined and used to recommend audio-visual compilations that appear as search results.

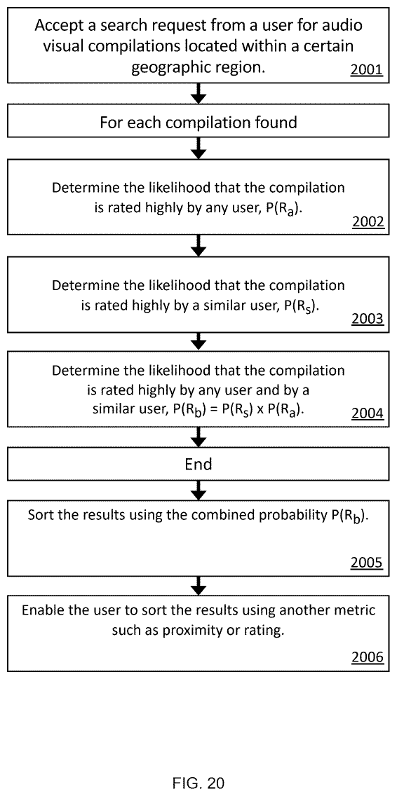

FIG. 20 shows a flowchart of a process for ranking and recommending search results, in accordance with the embodiment of the invention.

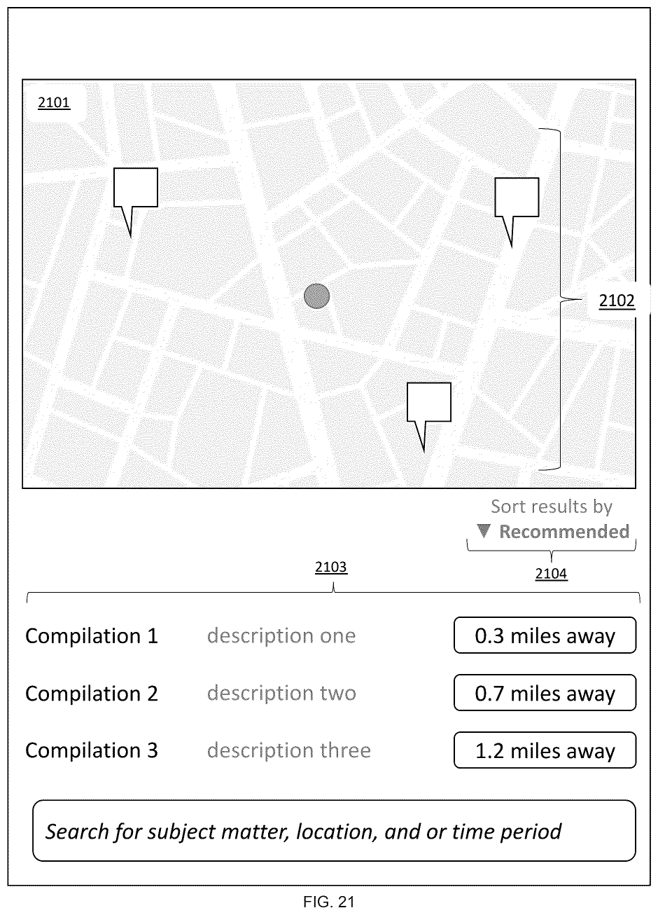

FIG. 21 illustrates an example of the user interface where recommended results are displayed after a search.

In one embodiment, ratings range from 1 to 5, with 1 being the lowest rating, and 5 being the highest rating. The likelihood of a compilation being rated highly is determined 2002 for any compilation in the set of results as:

$$\frac{\begin{matrix}the number of times a given compilation from \\ the set was rated 4 / 5 or 5 / 5\end{matrix}}{\begin{matrix}the number of times a given compilation \\ from the set was rated\end{matrix}}$$

Subsequently, the likelihood of a compilation being rated highly by similar visitors is determined 2003 as the class probability:

For all users above a similarity threshold relative to the searcher that have rated audio-visual compilations from the set,

$$\frac{the number of users who rated the compilation 4 / 5 or 5 / 5}{the number of users who rated the compilation}$$

Audio-visual compilations may feature themes such as natural history, archeology, sports history, or other categories. In one embodiment, the similarity of two distinct users can be estimated using dimensions such as their preferred themes for audio-visual compilations, the typical number of users in their group during past visits, and region of origin.

Nearest neighbor machine learning classifiers are used to predict membership within a classification. Using a nearest neighbor classifier, we could forecast whether or not the searcher ranks a compilation highly based on if most of the nearest neighbors, who in this case are similar users, rated it highly. In this case we are more concerned with the percentage of similar users who rated a compilation highly, as opposed to whether or not the searcher will rate a compilation highly.

After a search is completed and matching results are returned, for each result, there may be users of varying similarity to the searcher that will have provided a variety of ratings for the compilation. In one embodiment, for each compilation returned in a search result, the content recommendation model finds all users above a given similarity threshold relative to the searcher that have rated the compilation. Using a nearest-neighbor classifier with an optimized number of similar users, the model estimates the probability that the compilation is rated above ⅗ by similar users. This is the class probability defined above as:

For all users above a similarity threshold that have rated audio-visual compilations from the set,

$$\frac{the number of users who rated the compilation 4 / 5 or 5 / 5}{the number of users who rated the compilation}$$

In one embodiment, the content recommendation module 1011 uses previously provided ratings and data associated with the rating providers to train, test, and optimize the model, particularly with selection of the number of similar searchers to use with a nearest-neighbor classifier.

The content recommendation model provides two probabilities for each search result. P(Rₐ), the likelihood that the compilation is rated above 3 by any user, and P(Rₛ), the likelihood that the compilation is rated above 3 by a similar user. These probabilities are combined to estimate 2004 for any visitor-generated search 1902, the likelihood that any result 2103 will be rated highly by both a similar a visitor and by any visitor, P(R_{b}). This combined probability is determined as:

$$P ( {R}_{b} ) = P ( {R}_{a} ) \times P ( {R}_{s} )$$

In one embodiment, the set of results is sorted 2005 by this combined probability in descending order then presented to the user as recommended results following a search. Users may be able to sort 2006 the search results based on another metric such as proximity, average rating, or by name.

In one embodiment, the content-visitor matching subsystem 112b ranks and presents all available results to a user for a geographic region upon opening the application. The search is assumed to not have any search parameters.

In some embodiments, new audio-visual compilations, or audio-visual compilations that have not received enough ratings are either excluded from the model or provided with a baseline rating of ⅗.

The content recommendation module 1011 filters, sorts, and displays the audio-visual compilations within a geographic area based on likelihood of being rated highly by both a similar a visitor and by any visitor. If a searcher is in a geographic region with a plurality of geographically based audio-visual compilations 2102, search results sorted by average rating alone may omit an audio-visual compilation that has low average rating but is consistently rated highly by similar searchers. Conversely, only providing highly rated search results from similar searchers may ignore a highly rated search result that appeals to a traveler with niche interests who is specifically looking for a different experience. Sorting the results by the combined likelihoods 2104 ensures that highly rated content that was also rated highly by similar users appears atop the search results, followed by a mix of content that received high ratings from similar visitors and content that has received high ratings from all visitors. This may be particularly helpful for a group coordinator who visits geographical compilations individually but periodically conducts searches using his or her account on behalf of other users who are part of a group.

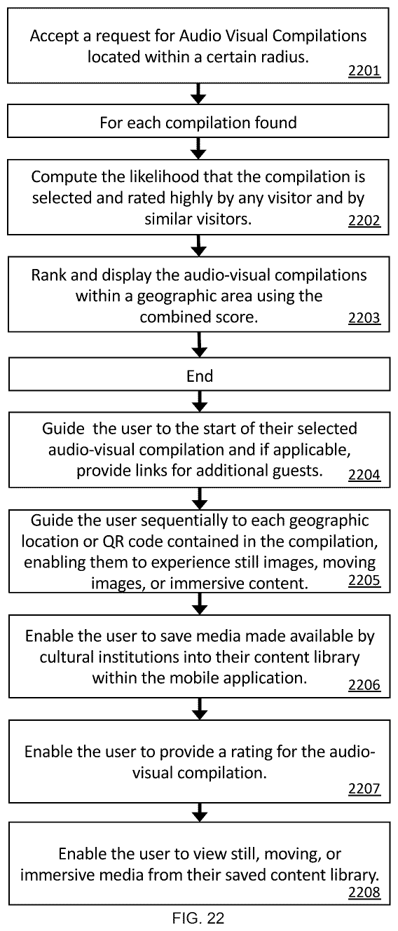

FIG. 22 illustrates an example method for enabling users to select a search result and be guided through a geographically linked audio-visual experience.

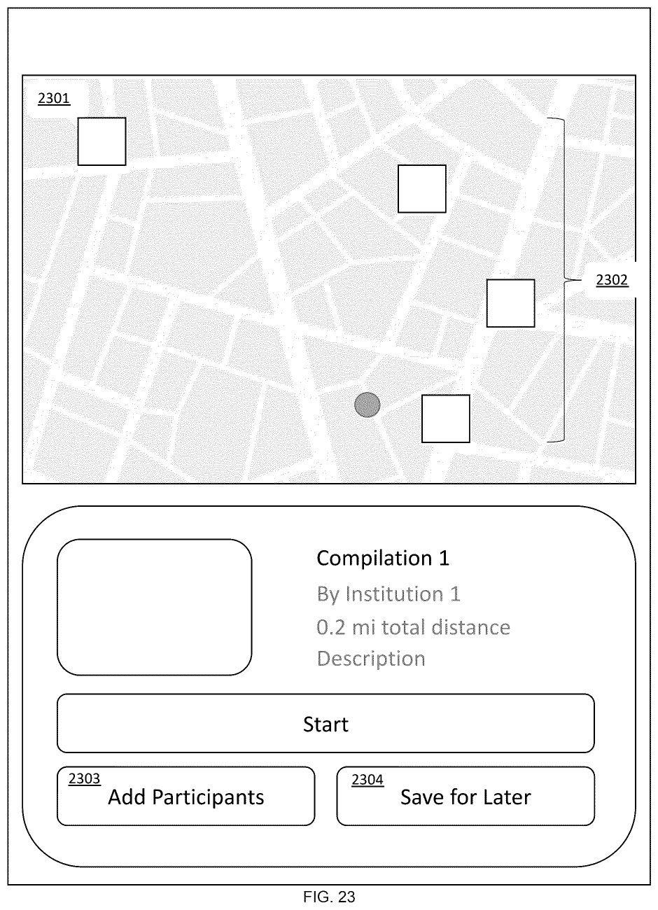

FIG. 23 illustrates an example of a user interface for a visitor selecting an audio-visual compilation that has been presented as part of a search result from the content-visitor matching subsystem.

### Content-Visitor Matching Subsystem—Visitor Forecast Model

The visitor forecast module 1012 creates and uses a statistical model to forecast periods when there may be a significant increase or decrease in the number of visitors to a geographic area associated with a cultural institution, its geographically linked audio-visual compilations, or a media item in its collection.

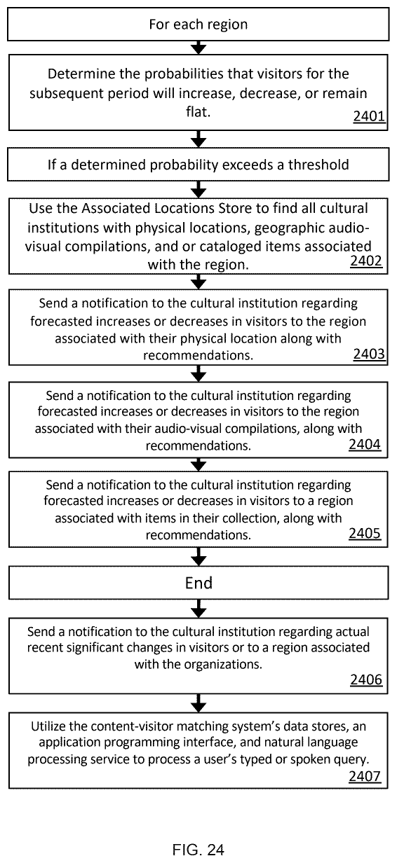

FIG. 24 shows a flowchart of the process used by the content-visitor matching system to provide actual and forecasted visitor data.

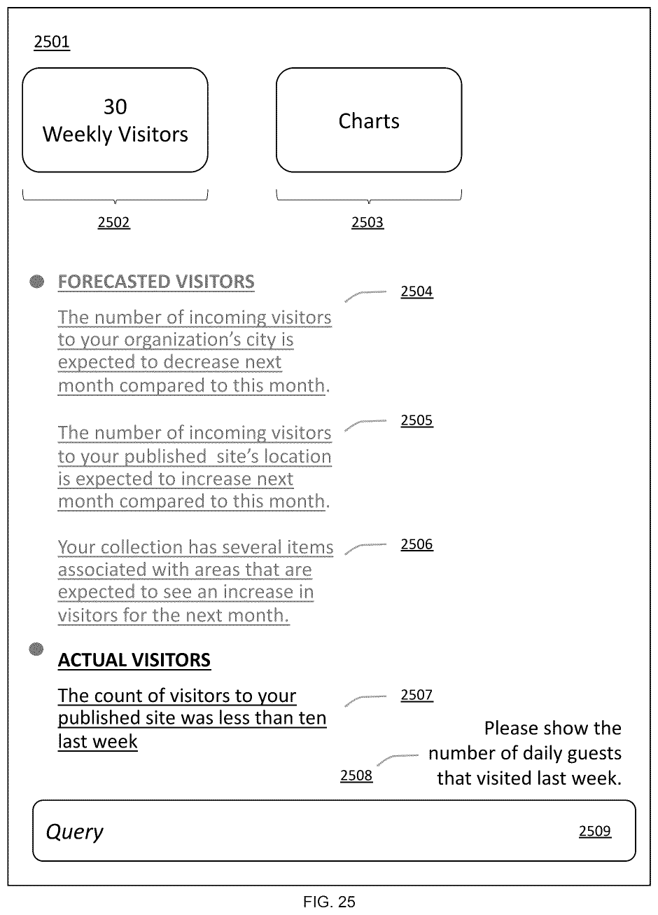

FIG. 25 Shows an example of the user interface where a cultural institution would receive a notification regarding forecasts of visitors for an upcoming period 2504 2505 2506, or actual visitors in a prior period 2507.

In one embodiment, the visitor forecast model is trained on data from the supplementary data store 1005 which contains regional metrics related to travel, macroeconomics, and local events. Using the output from the model, the visitor forecast module 1012 creates periodic forecasts at regional levels such as country, province, state, and or city. The forecasts determine 2401 the likelihood of each region having a significant increase in visitors, a significant decrease in visitors, or a stable number of visitors compared to the prior period. The training data is updated periodically.

The associated locations store 1006 contains data provided by each cultural institution 101b regarding the locations associated with its geographically linked audio-visual compilations, locations associated with items stored in the item preservation system's 110a item store 301, and the location of the institution itself.

For each regional forecast returned by the visitor forecast model, the visitor forecast module uses 2402 data from the associated locations store 1006 to notify 2403 cultural institutions of expected changes in visitors to the region of its institution. For example, the visitor insights interface 2501 displays a notification 2504 for an expected decrease in the number of visitors to a city where a cultural institution is located.

For each regional forecast returned by the visitor forecast model, the visitor forecast module uses data from the associated locations store 1006 to notify 2404 cultural institutions of expected changes in visitors to the region(s) of its audio-visual compilation(s). For example, the visitor insights interface 2501 displays a notification 2505 for an expected increase in the number of visitors to a city where an audio-visual compilation is located.

For each regional forecast returned by the visitor forecast model, the visitor forecast module uses data from the associated locations store 1006 to notify 2405 cultural institutions of expected changes in visitors to the region(s) associated with item(s) in its item preservation subsystem's 110a item store 301. For example, the visitor insights interface 2501 displays a notification 2506 for an expected increase in the number of visitors to a city associated with an item cataloged in the item preservation subsystem.

The notifications 2504 2505 2506 are also links that enable the recipient to view recommendations related to the notification.

The visitor forecast module also notifies 2406 the cultural institution of actual significant increases or decreases in guests who visited an associated location in recent prior periods 2507.

In some embodiments, the visitor forecast model can send notifications to cultural institutions that have associated locations that are in close proximity to a larger region that has a forecast. For example, an organization located in a suburb of a larger metropolitan area may receive notifications for the metropolitan area.

In one embodiment, the visitor forecast module creates a model that forecasts for a given region, the probabilities that visitors for the subsequent time period, typically at the month level, will increase, decrease, or remain relatively flat. For each region and each possible outcome (increased, decreased, or flat), the model generates a probability function that takes as input the recent regional travel metrics, macroeconomic metrics, and metrics related to local events (e.g. time period being forecasted, inbound travelers, outbound travelers, fuel prices, exchange rates, consumer sentiment, holidays, scheduled events, weather forecasts) then outputs a value representing the likelihood of the various possible outcomes for visitors in the subsequent time period (increased, decreased, or flat). The three likelihoods should sum to 1.

The visitor forecast module can forecast the likelihood of a region's visitors being increased, decreased, or flat by using a multi-class classification model such as multinomial logistic regression:

$$P ( Y = k \vert {X}_{1} , {X}_{2} , {X}_{3} , … {X}_{p} ) = \frac{{e}^{( {b}_{k 0} + {b}_{k 1} {X}_{1} + {b}_{k 2} {X}_{2} + … + {b}_{kp} {X}_{p} )}}{1 + {\sum }_{j = 1}^{k - 1} {e}^{( {b}_{j 0} + {b}_{j 1} {X}_{1} + {b}_{j 2} {X}_{2} + … + {b}_{jp} {X}_{p} )}}$$

Where Y represents one of the three possible outcomes k. X₁, X₂, . . . Xₚ are the predictor variables, and coefficients bₖ₀, bₖ₁, . . . , bₖₙ represent coefficients, or weights which are estimated during training. The numerator is an exponential of predictor variables weighted by the coefficients for each class k. The denominator is the normalization constant, which ensures that the sum of the likelihoods is 1.

In some embodiments, the forecast will only be presented to the user if the probability exceeds a threshold value. For example, given recent regional travel metrics, macroeconomic metrics, and metrics related to local events, the multinomial logistic regression model above may forecast that visitors to a location in the subsequent period will increase, decrease, or remain flat with probabilities of 0.20, 0.75, and 0.05 respectively. If a threshold probability is 0.7, a notification can be sent to a user forecasting a decrease in visitors.

Furthermore, in some embodiments, if a predictor variable is not numeric, it may be converted to multiple predictors, each representing a possible value of the non-numeric predictor that takes on a value of either 0 or 1.

Some implementations of the visitor forecast model can generate forecasts weekly or daily in addition to monthly.

In some implementations, if the relationship between predictors and visitors cannot be captured as a linear relationship, a nonlinear model generated using decision trees may be used to predict for a given region, whether visitors for the subsequent period will increase, decrease, or remain flat.

In some embodiments, the visitor forecast module may also capture counts of actual visitors to the institution and or to the institution's audio-visual compilations. A cultural institution user can subscribe to notifications related to significant changes in the number of actual visitors during a prior period. In one embodiment, changes for a given time period are considered significant when the standard deviation o of periodic visitors is less than the change in visitors for the most recent period |Δx|.

In addition to subscribing to automated notifications for actual or predicted significant changes in visitors, a cultural institution user 101a can select a custom combination of period, metric, operator, and numeric threshold for which they would want to receive notifications regarding actual past visitors. For example, a user can specify that they want to receive a notification if the weekly (period) count of visitors to the organization (metric) is less than (operator) ten (numeric threshold). The operators that a user can select include but are not limited to less than (<), greater than (>), equal to (=), less than or equal to (<=), and greater than or equal to (>=).

If any of the custom notification metrics have moved above or below their custom numeric thresholds, a notification is sent to the cultural institution user's mobile device via the application 2501. The notification 2507 specifies the metric and the corresponding threshold which it met or exceeded.

The notification 2507 is also a link that enables the recipient to view the individual data points that caused the metric to change significantly or move beyond a custom numeric threshold. Details are also shown regarding how the data points were entered into the content-visitor matching subsystem 110a.

Upon receiving a notification for an actual or forecasted metric, the data analysis query tool 2509 can be utilized to type or verbally ask questions related to the metric. To respond to a user's question 2508, any text that is typed or spoken must be converted into structured query language (SQL). Text-based queries are first normalized by programmatically removing punctuation before converting the query to SQL. For example, the text-based query “Please show the guests that visited last week” might be normalized by removing the third and fifth words “the” and “that”.

The conversion to structured query language (SQL) is achieved by using a custom trained named entity recognition model. Such models can be used to map commonly used words to the entities of the content-visitor matching subsystem 110a. The normalized query could be converted by the trained named entity recognition model to a form of SQL such as:

SELECT DATE(created_date), count (visitors) FROM visitors
WHERE created_date > = CURRENT_DATE − INTERVAL ‘7’ DAY
GROUP By DATE(created_date) ORDER By DATE(created_date);

If a voice-based query was provided, the query is converted to text using a speech-to-text application programming interface such as AWS Transcribe, then normalized and converted to SQL using the named entity recognition model.

The raw data returned from the query is formatted for readability and is also converted into conversational text using an application programming interface for accessing natural language processing features of a text generation model.

The formatted data and conversational text responses are returned to the application then displayed to the user via the interface. If a voice-based query was used, a text-to-speech application programming interface is used to read the response to the user.

Notifications regarding changes in visitors to a cultural institution's location may enable them to take actions that help to increase visitation or minimize reduction in visitation.

Notifications regarding changes in visitors to locations where a cultural institution has audio-visual compilations may enable the organization to take actions that help to increase user engagement or minimize a reduction in user engagement.

Notifications regarding changes in visitors to locations associated with an institution's items may enable them to take actions that increase engagement with content on the platform or encourage visitation to the institution itself.

### Media Matching Subsystem

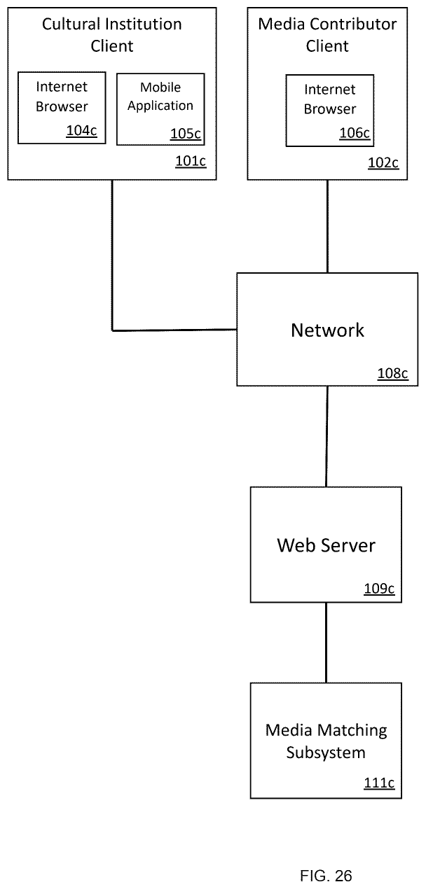

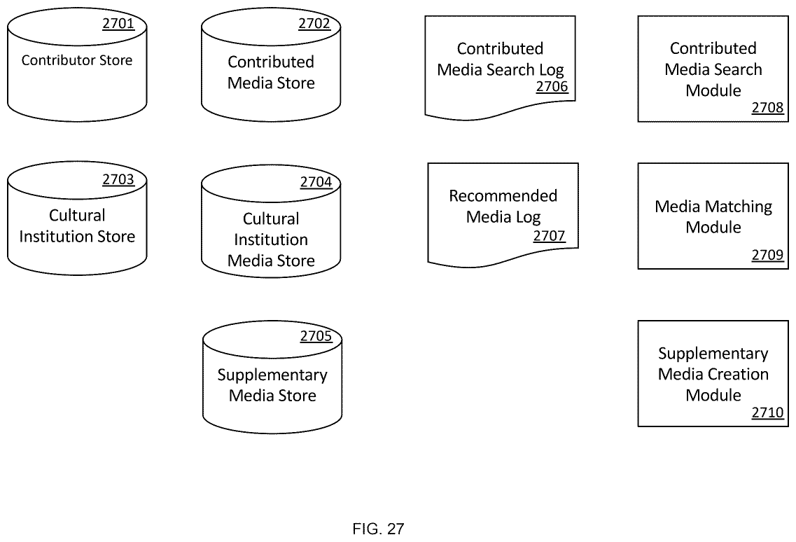

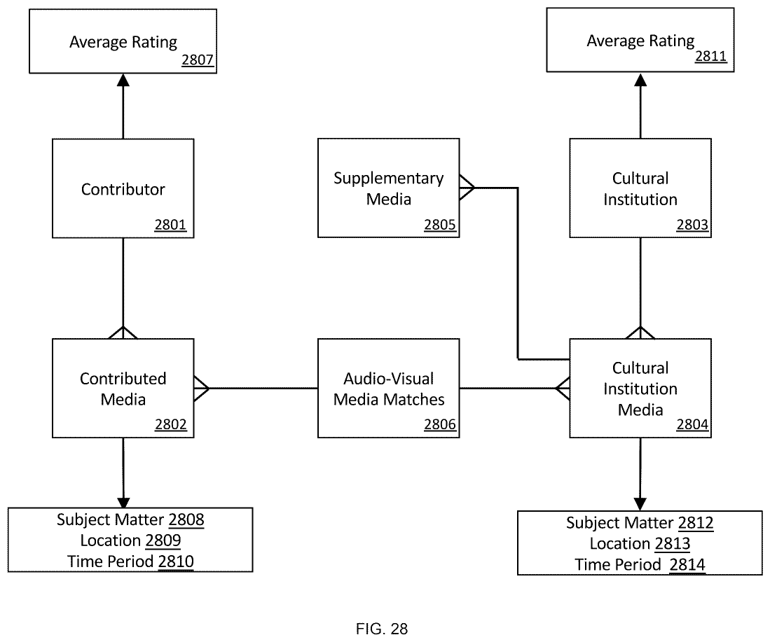

Referring to FIG. 26, FIG. 27, and FIG. 28, media contributors 102c are one type of user for the media matching subsystem 111c. Media contributors 102c store their digitized audio-visual content and its metadata in the system using a web browser 106c.

Cultural institutions 101c are another user of the media matching subsystem 111c. Cultural institutions 101c may store their digitized audio-visual content and its metadata into the system using a web browser 104c or mobile application 105c.

Cultural institutions 101c may also search for audio-visual content that media contributors 102c or other cultural institutions 101c have made available for potential use. Their search is initiated either through a browser via a computing device 104c or through the mobile application using a mobile device 105c.

The media matching subsystem 111c enables individuals or entities that have historically or culturally significant media to share it with media requestors for collaborative use in an audio-visual compilation or for other uses such as but not limited to exhibition and or research. The media matching subsystem 111c contains various components which are described below.

The contributor store 2701 contains data describing individuals or entities that own historically or culturally significant media and have chosen to allow others to be notified that their content may be available for collaborative use. Every contributor is represented by instances of the contributor class 2801. The contributor class contains attributes identifying the contributor such as user id and rating 2807.

The rating attribute 2807 of the contributor class 2801 is an average of all ratings for the contributor with a decay function applied based on when the rating was provided.

The contributed media store 2702 contains data describing static images, moving images, and or audio that have been provided by media contributors to be searched by media requestors for potential use. Every piece of contributed media is represented by instances of the contributed media class 2802, which contains attributes and metadata related to the contributed media file such as name, location, size, date created, and format. It also contains information regarding the content's subject matter (person(s), object(s), idea(s)) 2808, location 2809, time period 2810.

The cultural institution store 2703 contains data describing cultural institutions that may use the media matching subsystem to search for media contributed by individuals or entities, and to request for collaborative use of available media. Every cultural institution is represented by an instance of the cultural institution class 2803, which contains various attributes related to the institutions, such as institution id and rating 2811.

The rating attribute 2811 for a cultural institution object is a weighted average of all ratings for the cultural institution within the media matching subsystem with a decay factor applied to individual ratings based on when the rating was provided.

The cultural institution media store 2704 contains data describing static or moving images associated with items belonging to a cultural institution's collection. Each media file is represented by an instance of the cultural institution media class 2804, which contains attributes and metadata related to the media file such as name, location, size, date created, and format. It also contains information regarding the file content's subject matter (person(s), object(s), idea(s)) 2812, location 2813, time period 2814. The items in the cultural institution media store 2704 can either be made searchable for collaborative use, used as reference media for finding similar media from other contributors and or used as reference media for creating supplementary media.

The contributed media search module 2708 is utilized by cultural institutions 101c and contributors 102c to find media related to specific geographic areas, subject matter (person(s), object(s), idea(s)), and time periods by means of a user-generated search or periodic system-generated search. The contributed media search module 2708 also enables cultural institutions to select media that they wish to use and to subsequently sign agreements with media contributors regarding temporary collaborative use of that media. In another embodiment, the contributed media search module 2708 enables researchers associated with cultural institutions to select media that they wish to use and to subsequently sign agreements with media contributors regarding temporary use of that media.

The media matching module 2709 uses a statistical model to compare a provided reference media file to available contributed media files and returns a set of media files that are most similar to the reference media file. The media matching module 2709 also enables cultural institutions to select media that they wish to use and to subsequently sign agreements with media contributors regarding temporary collaborative use of the media. In another embodiment, the media matching module 2709 enables researchers associated with cultural institutions to select media that they wish to use and to subsequently sign agreements with media contributors regarding temporary use of that media.

The contributed media search log 2706 contains data describing text-based searches for contributed media, similarity-based searches for contributed media, and references to the set of results given the search criteria.

The recommended media log 2707 describes sets of contributed media that were suggested to media requestors who subscribed to periodic automated recommendations from the contributed media search module 2708 or the media matching module 2709. It also contains information regarding recommended items that media requestors have saved for later review or identified as not useful.

The supplementary media creation module 2710 is used by cultural institutions 101c to create static or moving images based on existing media or contextual descriptions. The supplementary media store 2705 contains names and files associated with media created by the supplementary media creation module. Every static or moving image is represented by an instance of the supplementary media class 2805, which also contains attributes and metadata related to the file such as name, size, date created, and format. Every instance of the supplementary media class 2805 is associated with the instance of the cultural institution media class 2804 that was used to create it.

The media matching subsystem's 111c contributor store 2701, contributed media store 2702, cultural institutions store 2703, cultural institution media store 2704, supplementary media store 2705, contributed media search log 2706, recommended media log 2707 described above require database management systems for writing and reading data.

The media matching subsystem 111c described above uses a cloud-based implementation and client-server architecture. Other configurations of implementation are also possible. The media matching subsystem 111c may also contain other stores and logs not represented here. Other parts of the system related to user authentication, network management, and firewalls are not material to the invention and therefore are not shown.

### Media Matching Subsystem—Media Matching Model

The media matching subsystem 111c enables individuals 102c or entities 101c to temporarily contribute culturally or historically significant media for use in collaborative audio-visual compilations created with content from two or more contributors. The individuals or entities contributing content label culturally or historically significant media with person(s), object(s), idea(s), location, and or time period.

The media matching subsystem 111c also enables individuals and cultural institutions to request notification for availability of contributed media that is similar to their own reference media content. Reference media refers to a media file whose metadata is used to find similar media.

Functions of the media matching subsystem can be accessed from the Item Preservation Subsystem and the Content-Visitor matching Subsystem. When a user within a cultural institution identifies a need for additional supporting media, they can access the media matching system 703 1403 1503 1603 where they can utilize the modules 2708 2709 2710 to find or create files. One of the available methods is the media matching model.

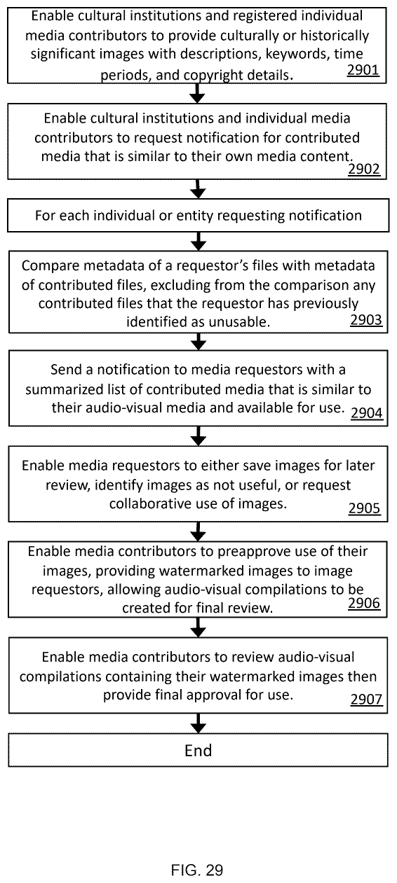

FIG. 29 illustrates an example method for media requestors with items of historic or cultural significance to find and use similar or related content from media contributors through use of the media matching subsystem.

For each individual or entity requesting notification, the media matching module 2709 compares 2903 metadata of reference audio-visual media files with metadata of contributed files.

For each individual or entity requesting notification, the media matching module 2709 excludes from the comparison any contributed files that the individual or entity has previously identified as unusable. Usability of a search result is stored in the recommended media log 2707.

Both the reference media file provided by the searcher, and the contributed media file provided by contributors have metadata which captures the person(s), object(s), idea(s), location, and or time period associated with the media. The metadata for reference media files will be compared to the metadata for contributed media files to determine similarity.

For each individual or entity requesting notification, for each of their provided reference files, the media matching module 2709 computes a similarity score for the reference file relative to all contributed files based on person(s), object(s), idea(s), location, and or time period. Depending on the goal of the individual or entity requesting notification, the similarity score may be weighted to emphasize person(s), thing(s), idea(s), location, or time period.

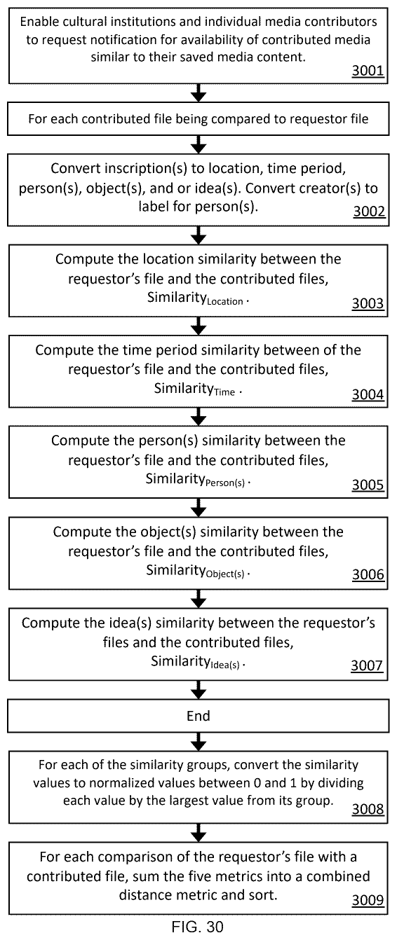

FIG. 30 illustrates an example method for determining the level of similarity between media files in the media matching subsystem

Similarity between two location attributes will be determined by the Haversine distance, which approximates the shortest distance between two points on a spherical surface. In this case we approximate the distance between towns, cities, states, or landmark locations that have been converted to latitude and longitude. This distance is determined as:

$${distance}_{Haversine} = 2 r {sin}^{- 1} ( \sqrt{{sin}^{2} ( \frac{( {lat}_{2} - {lat}_{1} )}{2} ) + cos ( {lat}_{1} ) cos ( {lat}_{2} ) {sin}^{2} ( \frac{( {lon}_{2} - {lon}_{1} )}{2} )} )$$

Where r=3,959 if distance is miles or 6,371 if distance is kilometers.
(lat₂−lat₁) refers to the latitude difference between the second and first location converted to radians. This difference is converted to radians by multiplying (lat₂−lat₁) and (π/180).
Lat₁ and Lat₂ refer to latitude of the first and second locations respectively. These locations have been converted from degrees to radians by multiplying the latitude value and (π/180).
(Ion₂−Ion₁) refers to the longitude difference between the second and first location converted to radians. This difference is converted to radians by multiplying (Ion₂−Ion₁) and (π/180).

This similarity calculation for location(s) is determined for the reference file relative to all available and eligible contributed files. The formatting of metadata for location(s) may be standardized to improve the accuracy of the comparison.

Similarity between sets of numeric time periods will be determined as the Euclidean distance between the sets of numeric time periods. If we have a reference file R whose metadata contains earliest and latest possible time periods (t_{1R}, t_{2R}), and a contributed file C whose metadata contains earliest and latest possible time periods (t_{1C}, t_{2C}), the similarity, or distance between these time periods can be determined as:

$${distance}_{Euclidean} ( R , C ) = \sqrt{{( {t}_{1 , R} - {t}_{1 , C} )}^{2} + {( {t}_{2 , R} - {t}_{2 , C} )}^{2}}$$

This similarity calculation for time period(s) is determined for the reference file relative to all available and eligible contributed files. The formatting of metadata for time period(s) may be standardized to improve the accuracy of the comparison. For example, a reference file labeled with a single definitive date may have to use that single date as the earliest and latest possible dates, enabling comparison with a contributed media file that contains a less certain date range.

Similarity between the person(s) attribute will be determined by the edit distance. For two names, the edit distance would be determined as the total number of edit operations required to convert one text string to another. Edit operations include text insertions, deletions, and replacements. For example, the edit distance of “Jon Smyth” and “John Smith” would be 2 (First, insert an “h”, Second, replace “y” with “i”).

In one embodiment, to improve accuracy of the results, names may be reordered to ensure alignment of the first name and last names prior to determining the edit distance. For example, two files labeled with persons “Jon Smyth” and “John Smith” have an edit distance of 2. If the reference file and contributed file were labeled with the persons “John Smith” and “Smyth, Jon” respectively, the increased number of required edit operations would result in an edit distance of greater than 2. As a result, these two files could be considered less similar than the two files labeled with the persons “John Smith” and “Jon Smyth”.

In one embodiment, to improve accuracy of the results, names may be converted to phonetic codes using a phonetic algorithm, resulting in each name being represented by data that captures how the name sounds. A string similarity metric such as the edit distance is then applied to the phonetic code, providing a metric that interprets how similar the names sound. For example, the phonetic codes for “Jon Smyth” and “John Smith” would be identical, resulting in an edit distance of 0, which could be interpreted as the names being very similar.

In some embodiments, two names that appear in media metadata can be compared using the edit distance of the text-based name, the edit distance of the phonetic code, or both.

This similarity calculation for person(s) is determined for the reference file relative to all available and eligible contributed files. The formatting of metadata for person(s) may be standardized to improve the accuracy of the comparison.

Similarity between the object(s) attribute will be determined by using pre-trained word embeddings to determine the cosine distance between words that have been converted into numerical vectors. Converting words into numerical vectors allows two different words with the same meaning to be represented by a single value, ensuring that similar media items whose object(s) metadata descriptions differ due to synonyms used can be identified as being similar. For example, two media items whose object(s) metadata values are the words “desk” and “writing table” would have a relatively high similarity metric.

Cosine distance between two objects whose metadata contain different yet synonymous words converted to vectors, W₁ and W₂, can be determined as:

$$d {istance}_{cosine} = 1 - \frac{{W}_{1} \cdot {W}_{2}}{{‖ {W}_{1} ‖}_{1} \cdot {‖ {W}_{2} ‖}_{2}}$$

Where the numerator W₁·W₂ is the dot product of the numerical vectors representing the words, and denominator ||W₁||₂·||W₂||₂ represents the product of the vectors' Euclidean lengths.

This similarity calculation for object(s) is determined for the reference file relative to all available and eligible contributed files. The formatting of metadata for object(s) may be standardized to improve the accuracy of the comparison.

Similarity between the idea(s) attribute will be determined by using pretrained sentence embeddings which can determine the cosine distance between sentences that have been converted into numerical vectors. Converting sentences into numerical vectors allows two different sentences with similar meaning and sentiment to be represented by similar values, ensuring that media items with similar context, meaning, and sentiment whose metadata varies in wording can be compared. Cosine distance between two sentences which have been converted to numerical vectors S₁ and S₂ is determined as:

$$d {istance}_{cosine} = 1 - \frac{{S}_{1} \cdot {S}_{2}}{{{‖ {S}_{1} ‖}_{1} \cdot ‖ {S}_{2} ‖}_{2}}$$

Where the numerator S₁·S₂ is the dot product of the numerical vectors representing the sentences, and denominator ||S₁||₂·||S₂||₂ represents the product of the sentence vectors' Euclidean lengths.

This similarity calculation for idea(s) is determined for the reference file relative to all available and eligible contributed files. The formatting of metadata for idea(s) may be standardized to improve the accuracy of the comparison.

For all media items being compared, the Haversine distances for location(s) will all be normalized to contain values between 0 and 1 by dividing all distances by the largest value in the set.

For all media items being compared, the Euclidean distances for time period(s) will all be normalized to contain values between 0 and 1 by dividing all distances by the largest value in the set.

For all media items being compared, the edit distances for person(s) will all be normalized to contain values between 0 and 1 by dividing all distances by the largest value in the set.

For all media items being compared, the cosine distances for object(s) will all be normalized to contain values between 0 and 1 by dividing all distances by the largest value in the set.

For all media items being compared, the cosine distances for idea(s) will all be normalized to contain values between 0 and 1 by dividing all distances by the largest value in the set. Similarity between the searcher's media and any contributed media can be determined as:

$$Similarity = {w}_{1} \cdot Haversine {Distance}_{location} + w 2 \cdot Euclidean {Distance}_{date range} + w 3 \cdot Edit {Distance}_{person ( s )} + w 4 \cdot Cosine {Distance}_{object ( s )} + w 5 \cdot Cosine {Distance}_{idea ( s )}$$

Where each distance is a normalized value between 0 and 1, and w₁, w₂, w₃, w₄, w₅ are optional weights applied to the distances.

Short inscriptions in media may provide additional labels for the person(s), place(s), time period(s), object(s), or idea(s) illustrated or captured by a piece of media. In one embodiment such inscriptions are converted to the appropriate search category i.e., person(s), place(s), time period(s), object(s), or idea(s), if they were not previously found in those categories. This would enable an inscription in a given file to be compared to person(s), place(s), time period(s), object(s), or idea(s) from another file. Such conversions can be enabled by use of a custom trained named entity recognition model, which can determine for a majority of words, which search category a word might belong to.

In another embodiment, longer inscriptions are compared with one another or with idea(s) using pretrained sentence embeddings which can determine the cosine distance between sentences that have been converted into numerical vectors. Converting sentences into numerical vectors allows two different sentences with similar meaning and sentiment to be represented by similar values, ensuring that media items with similar context, meaning, and sentiment whose metadata varies in wording can be compared.

In one embodiment, unclear inscriptions from one piece of media that are abbreviated, illegible, or misspelled can be compared to the best matching search categories of another piece of media using the appropriate distance metric then converted to that search category.

In instances where either the reference file or contributed file contains more than one person(s), place(s), object(s), or idea(s) in the metadata, the appropriate similarity metric is computed for each item, and the highest similarity value is used. If for example, the metadata for a reference media file contains two persons and it is compared to a contributed file whose metadata contains four persons, person 1 from the reference file is compared to all four persons in the contributed file. Person 2 from the reference file is then compared to all four persons in the contributed file. The pair with the highest similarity is used in the overall similarity calculation for the two files.

In one embodiment, the importance of date, name(s), object(s), idea(s), and or location for a requested media match can be increased or decreased via weights w₁, w₂, w₃, w₄, w₅ depending on the absence of a value in the metadata, search preferences, or desired accuracy.

For each individual or entity requesting notification, for each of their provided reference files, the media matching model ranks the search results by similarity to the provided reference file.

For each individual or entity requesting notification, the media matching subsystem sends a notification to the individual or entity and presents the user with a sorted list of contributed media that is above a similarity threshold and available for use.

In one embodiment, the media matching system can utilize the list of similar media results to also suggest compilations containing media that have high similarity for location, but varying similarities for name(s), object(s), idea(s), and or time period(s).

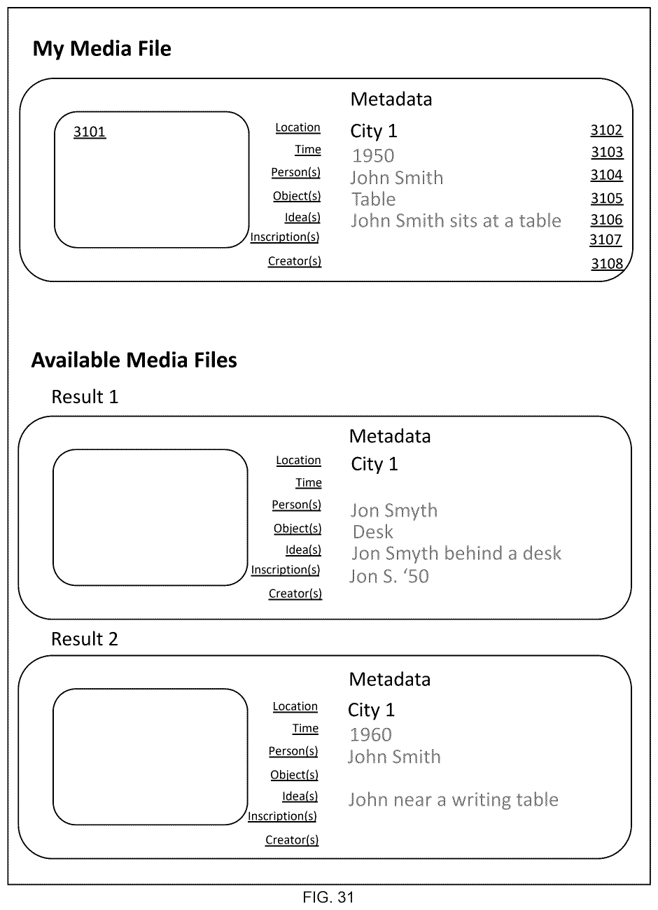

FIG. 31 is an example of a user interface that enables media requestors to be notified of contributed media that is similar to their provided reference media.

Media requestors have the option to either submit a request to the contributor for use of the media, save the media for later review, or identify the media as not useful. For each individual or entity that identifies media as not useful, the recommended media log 2707 captures this information. In some embodiments, a media requestor is able to undo the decision to identify media as not useful.

For each individual or entity that places media into the media matching subsystem, the media matching subsystem provides the option to have collaborative audio-visual compilations created on their behalf by a cultural institution or by the media matching service provider. With this option, copyright attribution would list the media owner(s) or contributors.

### Media Matching Subsystem—Supplementary Media Methodology

The media matching subsystem 111c enables cultural institutions 101c to supplement their existing media files by creating new media based on the style and context of existing media. These new media files may then be used to add context to cataloged items or audio-visual compilations.

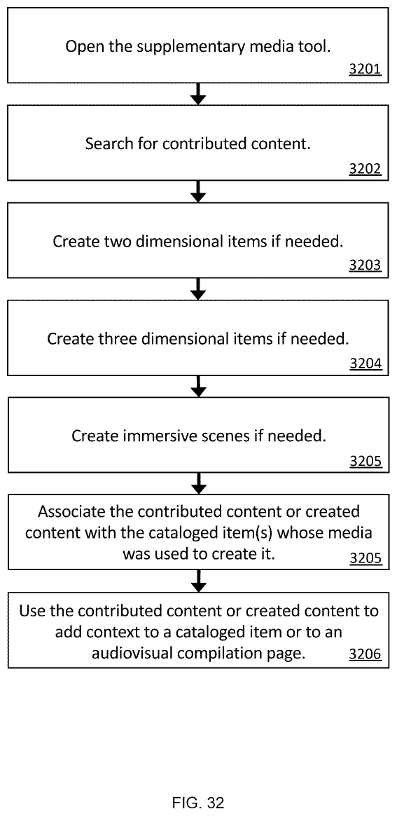

FIG. 32 illustrates an example method for cultural institutions to create media that adds context to existing media by using the media matching subsystem.

When a user within a cultural institution identifies a need for additional supporting media, they can access the functionality of the media matching system from the item preservation system interfaces 703 or the content-visitor matching system interfaces 1403 1503 1603 to utilize the Media Matching system's modules 2708 2709 2710 to find 3202 or create files. One of the available methods for finding files is through the supplementary media creation module 2710 where they are presented with options to create a two-dimensional file, a video, a three-dimensional file, or an immersive scene.

A cultural institution user can utilize the supplementary media creation module 2710 to add context to an item or audio-visual compilation by creating 3203 a two-dimensional static image from a text-based description. In one embodiment, a user can also create a two-dimensional static image by selecting a reference image whose style or content the user wishes to retain in the created image. Natural language processing techniques are used in conjunction with application programming interfaces to supply the image description and if applicable, the reference image to a diffusion model such as Stable Diffusion or DALL-E. The resulting image is saved in the supplementary media store 2705 and can be viewed from the user's application 105c by means of an application programming interface, at which time the user can select, reject, or recreate the image. A saved image will be associated with the cataloged item from which the reference image was provided.

A cultural institution user can utilize the supplementary media creation module 2710 to add context to an item or audio-visual compilation by creating 3203 video-based content from a text-based description. In one embodiment, a user can also create a video file by selecting a reference image whose style or content the user wishes to retain in the created video. Natural language processing techniques are used in conjunction with application programming interfaces to supply the image description and if applicable, the reference image to a diffusion model. The resulting video file is saved in the supplementary media store 2705 and can be viewed from the user's application 105c by means of an application programming interface, at which time the user can select, reject, or recreate the video. A saved video will be associated with the cataloged item from which the reference video was provided.

A cultural institution user can access the supplementary media creation module 2710 to add context to an item or audio-visual compilation by creating 3204 a three-dimensional object. In one embodiment, a cultural institution has one or more well-lit images of an item from its collection that has been stored in the cultural institution media store 2704. An application programming interface is used to upload a single image to an artificial intelligence-based three-dimensional model generator which can infer the complete shape of the object from the uploaded reference image.

In another embodiment, an application programming interface is used to upload multiple images to a photogrammetry-based three-dimensional model generator, which uses the various views of the object to identify points on the object, combine identified points into a mesh, then apply a texture based on the images. An application programming interface is then used to save the processed three-dimensional object in the media matching system's 111c supplementary media store 2705 in a standard format such as.obj, fbx,.glb, or.usdz. The three-dimensional object is viewable from the user's application 105c, at which time the user can select, reject, refine, or recreate the three-dimensional object. A saved three-dimensional object will be associated with the cataloged item from which the reference image or images were provided. A saved three-dimensional object may also be used as an object that a visitor-user can save as a digital souvenir after completing a geographically linked audio-visual experience.

A cultural institution user can utilize the supplementary media creation module 2710 to add context to an item or audio-visual compilation by creating 3205 an immersive scene. The immersive scene contains one or more two-dimensional images, videos, and or three-dimensional items which are all placed in a three-dimensional space relative to one another.

In one embodiment, a cultural institution user can utilize the immersive display tool for indoor compilations 1410 to select one or more two-dimensional images (in a format such as.png, jpg), videos (in a format such as.mp4), and or three-dimensional objects (in a format such as.obj,.fbx,.glb,.usdz) to create the immersive scene. The cultural institution user's mobile application 105c is used to import selected image(s), video(s), and three-dimensional object(s) into an augmented reality framework such as Unity, ARKit, or ARCore where they are placed relative to one another in three-dimensional space, anchored to a reference image or QR code, then configured for lighting and shadows. An immersive scene and its reference image will be saved in the supplementary media store 2705 then associated with the cataloged item(s) from which the reference image(s), video(s), or object(s) were provided.

In one embodiment, a cultural institution user can utilize the immersive display tool for outdoor compilations 1510, or regional compilations 1610 to select one or more two-dimensional images (in a format such as.png, jpg), videos (in a format such as.mp4), and or three-dimensional objects (in a format such as.obj, fbx,.glb,.usdz) to create the immersive scene. The cultural institution user's mobile application 105c is used to import the selected image(s), video(s), and three-dimensional object(s) into an augmented reality framework such as Unity, ARKit, or ARCore where they are placed relative to one another in three-dimensional space, anchored to GPS coordinates, assigned geographic heading, then configured for lighting and shadows. An immersive scene will be saved in the supplementary media store 2705 and associated with the cataloged item(s) from which the reference image(s), video(s), or object(s) were provided.

In one embodiment, a visitor user who has selected a geographically linked audio-visual experience containing an immersive scene would be notified upon arrival at the geographic checkpoint that the page includes augmented reality content.

The functionality of the media matching subsystem 111 can be accessed from the content-visitor matching subsystem 112 to add media and context to an indoor audio-visual compilation 1403, outdoor audio-visual compilation 1503, or regional audio-visual compilation 1603. The functionality of the media matching subsystem 111 can also be accessed from the item preservation subsystem 110 to add media and context to a cataloged item 703.

The system described herein encompasses three subsystems. The three subsystems—the item preservation subsystem 110, the media matching subsystem 111, and the content-visitor matching subsystem 112 are all necessary for the invention to function as intended. Furthermore, all methods associated with these systems are necessary for the invention to function as intended.

The modules described in the previous sections are related sets of operations implemented on data by computer applications.

The stores described in the previous sections are locations within a computer readable storage medium containing data describing a related set of activities.

The system class diagrams contain classes, which may correspond to database tables or reports. Instances of classes may also be referred to as objects and correspond to records in a database table.

Media refers to videos, music, and photographs that are stored as a particular type of file on a computing device.

Audio-visual compilations will enable visitors to be guided to locations via a mobile device where they can experience images and sounds related to culturally and or historically significant subject matter.

In one embodiment, a client device 101, 102, 103 is any computing device having one or more processors, memory, storage, and networking hardware. A client device also has an operating system onto which an internet browser or a mobile application is installed, enabling access to the subsystems.

A cultural institution user refers to individual users of the mobile application who access the systems from a cultural institution client device 101 which has an internet browser 104 or a mobile application 105 installed.

A media contributor user refers to individual users who access the media matching system from a client device 102.

A visitor user refers to individual users of the mobile application 107b who search for audio-visual compilations.

The system and subsystems described herein utilize a cloud-based implementation and client-server architecture however other configurations for implementation are possible.

What is claimed is:

1. A system for providing and recommending cultural content, comprising:
one or more processors and one or more memory;
an item preservation subsystem configured to manage one or more cultural content items, the item preservation subsystem having one or more of:
an item creation module configured to store the one or more cultural content items;
a document module configured to associate one or more document items with the one or more cultural content items;
a periodic item review module configured to store one or more item reviews and associate the one or more item reviews with the one or more cultural content items; and
a data analysis module configured to provide one or more user selectable notifications for the one or more cultural content items, wherein the one or more user selectable notifications is associated with one or more metrics;
a media matching subsystem configured to enable sharing of one or more media items, the media matching subsystem having one or more of:
a contributed media search module configured to receive one or more first search parameters and to return a list of the one or more media items relevant to the one or more first search parameters; and
a media matching module configured to compare one or more provided media items to the one or more media items to find one or more similar media items and provide the one or more similar media items; and
a supplementary media creation module configured to receive one or more descriptions and or one or more original media items in order to create one or more digitally derived media items relevant to the one or more descriptions and or the one or original more media items;
a content-visitor subsystem configured to provide one or more items to a user, the content-visitor subsystem having one or more of:
a compilation module configured to compile one or more multi-media items associated with the one or more cultural content items to form one or more multimedia compilations;
a user search module configured to receive one or more second parameters, and to return a list of multimedia compilations relevant to the one or more second parameters;
a content recommendation module configured to recommend one or more multimedia compilations to a user;
a rating module configured to apply one or more ratings to one or more of:
one or more multimedia compilations in the list of multimedia compilations; or
one or more of the multimedia compilations recommended to the user, wherein one or more of the item preservation subsystem, the media matching subsystem, or the content-visitor subsystem are stored in the one or more memory and executed by the one or more processors.

2. The system of claim 1, wherein the data analysis module is further configured to:
calculate one or more statistics of the one or more metrics; and
provide the one or more user selectable notifications in response to the one or more metrics meeting one or more thresholds.

3. The system of claim 1, wherein the content-visitor subsystem further comprises:
a visitor forecast module configured to provide one or more forecasts of visitors to one or more of a location associated with one or more cultural content items, or a location of the one or more multimedia compilations.

4. The system of claim 1, wherein the one or more first search parameters include one or more of: an entity name, a time period, a radius from a current location, or a user selected location.

5. The system of claim 1, wherein the content recommendation module further comprises:
a similarity detection module configured to determine one or more similar users to the user and to calculate at least one rating probability of the one or more multimedia compilations based on the one or more similar users, wherein the one or more multimedia compilations are recommended based at least in part on the at least one rating probability.

6. A computer-implemented method, executed by one more processors, of recommending cultural content, comprising:
receiving one or more search parameters from a user, wherein the one or more search parameters include at least a location;
filtering one or more content items using the one or more search parameters to form a first subset of content items;
determining, using one or more statistical models, a first rating probability and a second rating probability for each content item in the first subset of content items;
calculating, for each content item in the first subset of content items, a ranking using at least the first rating probability and the second rating probability;
ordering the first subset of content items using the ranking to form a ranked first subset of content items; and
outputting the ranked first subset of content items using the ranked first subset of content items.

7. The computer-implemented method of claim 6, further comprising:
providing one or more additional parameters after outputting the first ranked subset of content items; and
re-ordering the first ranked subset of content items in response to selection of one or more of the one or more additional parameters; and
outputting the re-ordered first ranked subset of content items.

8. The method of claim 6, wherein determining the first rating probability for each content item further comprises:
dividing a number of times each content item was ranked above a threshold value by a total number of times each content item was ranked.

9. The method of claim 6, wherein determining the second rating probability for each content item further comprises:
determining one or more users similar to the user; and
dividing a number of times each content item was ranked above a threshold by the one or more users similar to the user by a total number of the one or more users similar to the user.

10. The method of claim 9, wherein the one or more users similar to the user is determined by using nearest neighbor machine learning classifiers.

11. The computer-implemented method of claim 6, wherein the one or more search parameters include one or more of: a person, an entity, one or more keywords, or a time period.

12. The computer-implemented method of claim 6, wherein the filtering is performed using at least one named entity recognition model.

13. A computer-implemented method, executed by one or more processors, of user forecasting, comprising:
determining, using one or more forecasting models, one or more visitor traffic forecasts;
determining a location of the one or more visitor traffic forecasts, in response to the one or more visitor traffic forecasts being above a threshold;
searching one or more datastores for one or more cultural institutions corresponding to the location;
notifying the one or more cultural institutions of the one or more visitor traffic forecasts; and
providing the one or more cultural institutions with one or more recommendations based on the one or more visitor traffic forecasts.

14. The computer-implemented method of claim 13, wherein the one or more visitor traffic forecasts is one or more of a probability of increased traffic, a probability of decreased traffic, or a probability of unchanged traffic.

15. The computer-implemented method of claim 14, wherein the probability of increased traffic, the probability of decreased traffic, or the probability of unchanged traffic are calculated using multinomial logistic regression.

16. A computer-implemented method, executed by one or more processors, of media matching, comprising:
storing one or more contributed media items, each of the one or more contributed media items having one or more first metadata items;
registering one or more media items each of the one or more media items having one or more second metadata items;
calculating, using one or more similarity methods, one or more similarity values for each of the one or more contributed media items utilizing the one or more first metadata items and the one or more second metadata items;
calculating an overall similarity value for each of the contributed media items by normalizing the one or more similarity values to form one or more normalized similarity values, and summing the normalized one or more similarity values; and
outputting, at least one contributed media item having an overall similarity value above a threshold.

17. The computer-implemented method of claim 16, wherein the one or more first metadata items and the one or more second metadata items are one or more of: a name, an entity, one or more keywords, a location, or a time period.

18. The computer-implemented method of claim 16, wherein the one or more similarity methods is one of: a Haversine distance, a Euclidean distance, a Cosine distance, an edit distance.

19. The computer-implemented method of claim 16, wherein one or more contributed items having a location similarity value above a threshold are suggested for a media compilation.
